(19) United States
(12) Patent Application Publication
(10) Pub. No.: US 2023/0259860 A1
(43) Pub. Date: Aug. 17, 2023

(54) CROSS FRAMEWORK VALIDATION OF COMPLIANCE, MATURITY AND SUBSEQUENT RISK NEEDED FOR; REMEDIATION, REPORTING AND DECISIONING

(71) Applicant: AJAY SARKAR, ENCINITAS, CA (US)

(72) Inventor: AJAY SARKAR, ENCINITAS, CA (US)

(21) Appl. No.: 18/084,549

(22) Filed: Dec. 20, 2022

Related U.S. Application Data
(63) Continuation-in-part of application No. 17/139,939, filed on Dec. 31, 2020, now Pat. No. 11,640,570.

(51) Int. Cl. G06Q 10/0637; G06Q 10/0635

(52) U.S. Cl. CPC G06Q 10/06375; G06Q 10/0635

(57) ABSTRACT

In one aspect, a computerized advanced common controls framework (ACCF) method for all risk domains of cyber security as prescribed in each framework comprising: providing a risk identification, quantification, and mitigation engine delivery platform of an entity; obtaining a set of Control Frameworks (CFs) related to a risk identification, quantification, and mitigation engine delivery of the entity; creating an ACCF from the set of CFs, wherein the ACCF comprises a collection of CFs that when combined enable a commingling of individual controls; and with the risk identification, quantification, and mitigation engine delivery platform of an entity, applying the ACCF to perform an operational and compliance risk reporting.

### CLAIM OF PRIORITY

This application claims priority to and is a continuation-in-part of U.S. patent application Ser. No. 17/139,939 filed on Dec. 31, 2020, and titled METHODS AND SYSTEMS OF RISK IDENTIFICATION, QUANTIFICATION, BENCHMARKING AND MITIGATION ENGINE DELIVERY. This application is hereby incorporated by reference in its entirety.

### FIELD OF INVENTION

This invention relates to computer and network security and more specifically to cross framework validation of compliance, maturity and subsequent risk needed for; remediation, reporting and decisioning.

### BACKGROUND

Executives and companies across different industries are faced with the daunting task of identifying, understanding, and managing ever-evolving risk and compliance threats and challenges in their organizations. risk identification and management activities are often conducted by way of manual assessments and audits. Such manual assessments and audits only provide a brief snapshot of risk at a moment in time and do not keep pace with ongoing enterprise threats and challenges. Current risk management programs are often decentralized, static and reactive and their design has focused on governance and process rather than real-time risk identification and quantification of risk exposure. This can hamper Boards' abilities to make forward-looking risk mitigation decisions and investments.

In between such manual assessments and audits, it is difficult to make an accurate assessment of risk given the volume and disparate nature of the data that is needed and available at any point in time to conduct such a review. Data sources can be limited, incomplete and opaque.

In addition, organizational change that occurs in between manual assessments and audits can impact risk profile. Examples of change include new projects and programs, employee changes, new systems, vendors, users, administrators and new compliance laws, regulations, and standards.

The risks to an enterprise can include various factors, including, inter alia: security and data privacy breaches (e.g. which threaten C-level jobs, potentially cost organizations millions of dollars, and can have personal legal implications for board members); data maintenance and storage issues; broken connectivity between security strategy and business initiatives; fragmented solutions covering security, privacy and compliance; regulatory enforcement activity; moving applications to a cloud-computing platform; and an inability to quantify the associated risk. Accordingly, a solution is needed that is a real-time, on-demand quantification tool that provides an enterprise-wide, centralized view of an organization's current risk profile and risk exposure.

### SUMMARY OF THE INVENTION

In one aspect, a computerized advanced common controls framework (ACCF) method for all risk domains of cyber security as prescribed in each framework comprising: providing a risk identification, quantification, and mitigation engine delivery platform of an entity; obtaining a set of Control Frameworks (CFs) related to a risk identification, quantification, and mitigation engine delivery of the entity; creating an ACCF from the set of CFs, wherein the ACCF comprises a collection of CFs that when combined enable a commingling of individual controls; and with the risk identification, quantification, and mitigation engine delivery platform of an entity, applying the ACCF to perform an operational and compliance risk reporting.

### BRIEF DESCRIPTION OF THE DRAWINGS

FIG. 1 illustrates an example process for implementing risk identification, quantification, and mitigation engine delivery, according to some embodiments.

FIG. 2 illustrates an example risk identification, quantification, and mitigation engine delivery platform, according to some embodiments.

FIG. 3 illustrates an example process for implementing risk identification, quantification, and mitigation engine delivery platform, according to some embodiments.

FIG. 4 illustrates an example risk assessment process, according to some embodiments.

FIG. 5 illustrates an example automatic risk value calculation process, according to some embodiments.

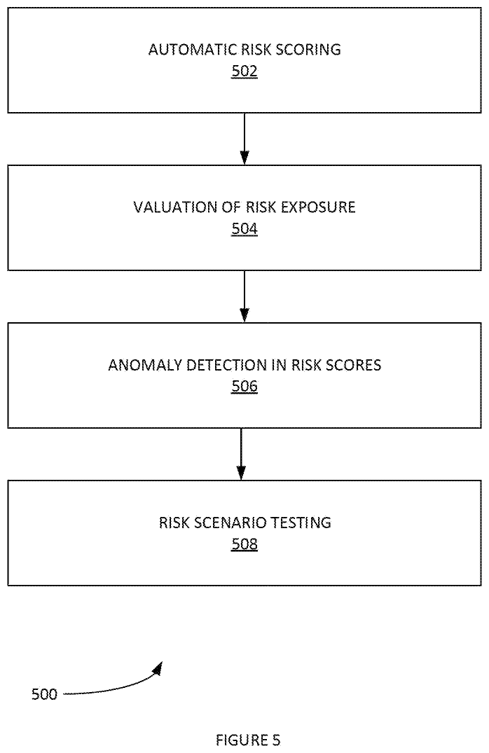

FIG. 6 illustrates an example automatic risk value calculation process, according to some embodiments.

FIG. 7 illustrates an example data collection, reporting and communication process, according to some embodiments.

FIG. 8 illustrates an example process for generating a report using NLG, according to some embodiments.

FIG. 9 illustrates a risk identification, quantification, and mitigation engine delivery platform with modularized-core capabilities and components, according to some embodiments.

FIG. 10 illustrates an example process for enterprise risk analysis, according to some embodiments.

FIG. 11 illustrates an example process for implementing a risk architecture, according to some embodiments.

FIG. 12 illustrates an example hardware risk information system for implementing an agent system for hardware risk information, according to some embodiments.

FIG. 13 illustrates an example risk management hardware device according to some embodiments.

FIG. 14 illustrates an example process for using a risk management hardware device for calculating the risk value of an enterprise asset, according to some embodiments.

FIG. 15 illustrates a system of risk management software architecture according to some embodiments.

FIG. 16 illustrates an example process implementing automated risk value calculation, according to some embodiments.

FIG. 17 illustrates an example process for determining a valuation of risk exposure, according to some embodiments.

FIG. 18 illustrates an example process for determining a risk remediation cost, according to some embodiments.

FIG. 19 illustrates an example process for anomaly detection in risk values, according to some embodiments.

FIG. 20 illustrates an example process for industry benchmarking, according to some embodiments.

FIG. 21 illustrates an example process for risk scenario testing, according to some embodiments.

FIG. 22 illustrates an example process implemented using automatic questionnaires and NLG, according to some embodiments.

FIG. 23 illustrates an example process implemented using reporting using NLG, according to some embodiments.

FIG. 24 illustrates an example process of automatic role assignment for role-based access control, according to some embodiments.

FIG. 25 illustrates an example process implemented using intelligence for adding risk value calculation, according to some embodiments.

FIG. 26 illustrates an example system for aggregating risk parameters, according to some embodiments.

FIG. 27 illustrates an example ACCF process, according to some embodiments.

FIG. 28 illustrates an example baseline set of control requirements, according to some embodiments.

FIG. 29 illustrates an example process for optimizing a controls environment, according to some embodiments.

FIG. 30 illustrates an example schematic showing ACCF rationalization, according to some embodiments.

FIG. 31 illustrates an example process for implementing a cross walk, according to some embodiments.

FIG. 32 illustrates an example process for a carve out, according to some embodiments.

FIG. 33 illustrates an ACCF example, according to some embodiments.

FIG. 34 illustrates an example process for implementing a curated carve-out, according to some embodiments.

FIG. 35 depicts an example computing system that can be configured to perform any one of the processes provided herein.

FIG. 36 illustrates an example common control model, according to some embodiments.

The Figures described above are a representative set and are not exhaustive with respect to embodying the invention.

### DESCRIPTION

Disclosed are a system, method, and article of an advanced common controls framework (ACCF) for all risk domains of cyber security as prescribed in each framework. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment;’ ‘an embodiment;’ ‘one example,’ or similar language means that a particular feature, structure, or characteristic described in connection with the embodiment is included in at least one embodiment of the present invention. Thus, appearances of the phrases ‘in one embodiment;’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) is a set of subroutine definitions, communication protocols, and/or tools for building software. An API can be a set of clearly defined methods of communication among various components.

Application-specific integrated circuit (ASIC) is an integrated circuit (IC) chip customized for a particular use.

Artificial Intelligence (AI) is the simulation of intelligent behavior in computers, or the ability of machines to mimic intelligent human behavior.

Business Initiative(s) can include a specific set of business priorities and strategic goals that have been determined by the organization. Business Initiatives can include ways the organization/enterprise indicates what its vision is, how it will improve, and what it believes it needs to do in order to be successful.

Business Intelligence (BI) is the analysis of business information in a way to provide historical, current, and future predictive views of business performance. BI is descriptive analytics.

Cloud computing can involve deploying groups of remote servers and/or software networks that allow centralized data storage and online access to computer services or resources. These groups of remote servers and/or software networks can be a collection of remote computing services.

Corporate Intelligence (CI) includes the analysis of Business Intelligence data by AI in order to optimize business performance.

Common Vulnerabilities and Exposures (CVE) can be a collection of publicly known software vulnerabilities. The CVE system provides a reference-method for publicly known information-security vulnerabilities and exposures.

Control Effectiveness is a measure of whether a given process/control is contributing to the reduction of risk measured as its efficacy or maturity and has other derivatives including applied to mitigate unconscious bias from non-technical outcomes. A measure of whether a security or privacy control contributes to the reduction of information security or privacy risk.

CXO is an abbreviation for a top-level officer within a company, where the “X” could stand for, inter alia, “Executive,” “Operations,” “Marketing,” “Privacy,” “Security” or “Risk.”

Cyber Security is the enhancement of IT and Physical Security with the holistic view and coverage of business/operations/systems embodying the trifecta construct of; Confidentiality/Integrity/Availability covering People/Process/Technology protecting business digital and physical assets in-transit/in-process/at-rest with techniques/methods/controls defined and placed to protect the brand from critical risks/cyber threats.

Data Model (DM) can be a model that organizes data elements and determines the structure of data.

Deep Learning (DL also known as deep structured learning) is part of a broader family of machine learning methods based on artificial neural networks with representation learning. Learning can be supervised, semi-supervised or unsupervised.

Enterprise risk management (ERM) in business includes the methods and processes used by organizations to identify, assess, manage, and mitigate risks and identify opportunities to support the achievement of business objectives.

Exponentiation is a mathematical operation, written as bⁿ, involving two numbers, the base b and the exponent or power n, and pronounced as “b raised to the power of n”. When n is a positive integer, exponentiation corresponds to repeated multiplication of the base: that is, bⁿ is the product of multiplying n bases.

Google Cloud Platform (GCP) is a suite of cloud computing services that runs on the same infrastructure that Google uses internally for its end-user products.

Gunicorn is a Python Web Server Gateway Interface (WSGI) HTTP server. It is a pre-fork worker model, ported from Ruby's Unicorn project. The Gunicorn server is broadly compatible with a number of web frameworks, simply implemented, light on server resources and fairly fast.[3] It is often paired with NGINX, as the two have complementary features. Herein, it is provided by way of example, and it is noted that other WSGIs can be utilized in lieu of Gunicorn in various example embodiments.

Internet of things (IoT)/Industrial Internet of Things (IIoT) describes the network of physical objects that are embedded with sensors, software, and other technologies for the purpose of connecting and exchanging data with other devices and systems over the Internet.

Machine Learning can be the application of AI in a way that allows the system to learn for itself through repeated iterations. It can involve the use of algorithms to parse data and learn from it. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning.

Natural-language generation (NLG) can be a software process that transforms structured data into natural language. NLG can be used to produce long form content for organizations to automate custom reports. NLG can produce custom content for a web or mobile application. NLG can be used to generate short blurbs of text in interactive conversations (e.g. with a chatbot-type system, etc.) which can be read out by a text-to-speech system.

Network interface controller (NIC) is a computer hardware component that connects a computer to a computer network.

Neural network is an artificial neural network composed of artificial neurons or nodes.

Neural Network Processing Unit (NNPU) is a specialized hardware accelerator and/or computer system designed to accelerate specified artificial neural networks.

National Institute of Standards and Technology (NIST) is a physical sciences laboratory and non-regulatory agency of the United States Department of Commerce.

Predictive Analytics includes the finding of patterns from data using mathematical models that predict future outcomes. Predictive Analytics encompasses a variety of statistical techniques from data mining, predictive modeling, and machine learning, that analyze current and historical facts to make predictions about future or otherwise unknown events. In business, predictive models exploit patterns found in historical and transactional data to identify risks and opportunities. Models can capture relationships among many factors to allow assessment of risk or potential risk associated with a particular set of conditions, guiding decision-making for candidate transactions.

Representational state transfer (REST) is a software architectural style that was created to guide the design and development of the architecture for the World Wide Web. REST defines a set of constraints for how the architecture of an Internet-scale distributed hypermedia system, such as the Web, should behave. The REST architectural style emphasizes the scalability of interactions between components, uniform interfaces, independent deployment of components, and the creation of a layered architecture to facilitate caching components to reduce user-perceived latency, enforce security, and encapsulate legacy systems.

Risk Program, and Portfolio Management (RPPM). Risk management is the practice of initiating, planning, executing, controlling, and closing the work of a team to achieve specific risk goals and meet specific success criteria at the specified time. Program management is the process of managing several related risks, often with the intention of improving an organization's overall risk performance. Portfolio management is the selection, prioritization and control of an organization's risks and programs in line with its strategic objectives and capacity to deliver.

Risk context is establishing the context defining the external and internal parameters to be taken into account when managing risk and setting the scope and risk criteria for the risk management policy.

Risk management is coordinated activities to direct and control an organization with regard to risk.

Risk management framework is a set of components that provide the foundations and organizational arrangements for designing, implementing, monitoring, reviewing and continually improving risk management throughout the organization.

Risk management process is the systematic application of management policies, procedures, and practices to the activities of communicating, consulting, establishing the context, and identifying, analyzing, evaluating, treating, monitoring, and reviewing risk.

Risk profile is a description of any set of risks and can contain this that relate to the whole or part of the organization or as otherwise defined.

Risk event is the occurrence or change of a particular set of circumstances.

Risk likelihood is the chance of a risk happening—used to refer to the chance of something happening, whether defined, measured or determined objectively or subjectively, qualitatively, or quantitatively, and described using general terms or mathematically (e.g. such as a probability or a frequency over a given time period).

Risk probability is the measure of the chance of an occurrence expressed as a number between 0 and 1, where 0 is impossibility and 1 is absolute certainty.

Risk frequency is the number of events or outcomes per defined unit of time.

Risk consequence is the outcome of a risk event affecting objectives.

Vulnerability is the intrinsic properties of something resulting in susceptibility to a risk source that can lead to an event with a consequence.

Risk attitude is the organization's approach to assess and eventually pursue, retain, take, or turn away from risk.

Risk appetite is the amount and type of risk that an organization is willing to pursue or retain.

Risk tolerance is the organization's or stakeholder's readiness to bear the risk after risk treatment in order to achieve its objectives.

Risk control is a measure that is modifying risks and my include any process, policy, device, practice, or other actions which modify risk.

Residual risk is the risk remaining after risk treatment and can be unidentified risk or retained risk.

Risk quantification is the process of evaluating risks that have been identified and developing data needed for making decisions as to what should be done about them.

Risk qualification (prioritization) of identified all the risks to figure out which ones have priority over others, either by imminence or, most likely, by greatest probability and impact.

Risk mitigation is the process of planning for disasters (e.g. threats) and having a way to lessen negative impacts. It refers to the process of planning and developing methods and options to reduce threats/risks to business, project, or operational objectives.

Persona is the aspect of a role or character that is adopted for presentment of information defined via neuroscience studies of fifteen (15) prospective users of the information provided both graphically, dynamically and/or via static visual presentment. Three separate personas are defined as Operational, Management and Executive for the embodiments reflective herein.

Recurrent neural network (RNN) is a class of artificial neural networks where connections between nodes form a directed graph along a temporal sequence. In one example, derived from feedforward neural networks, RNNs can use their internal state (memory) to process variable length sequences of inputs.

Spider chart is a graphical method of displaying multivariate data in the form of a two-dimensional chart of three or more quantitative variables represented on axes starting from the same point. Various heuristics, such as algorithms that plot data as the maximal total area, can be applied to sort the variables (e.g. axes) into relative positions that reveal distinct correlations, trade-offs, and a multitude of other comparative measures.

Synthetic data can be any production data applicable to a given situation that are not obtained by direct measurement. This can include data generated by a computer simulation(s).

### Example Methods

Disclosed are various embodiments of a risk identification, quantification, and mitigation engine. The risk identification, quantification, and mitigation engine provide various ERM functionalities. The risk identification, quantification, and mitigation engine can leverage various advanced algorithmic technologies that include AI, Machine Learning, and block chain systems. The risk identification, quantification, and mitigation engine can provide proactive and continuous risk monitoring and management of all key risks collectively across an organization/entity. The risk identification, quantification, and mitigation engine can be used to manage continuous risk exposure, as well as assisting with the reduction of residual risk.

Accordingly, examples of a risk identification, quantification, and mitigation engine are provided. A risk identification, quantification, and mitigation engine can obtain data and analyze multiple complex risk problems. The risk identification, quantification, and mitigation engine can analyze, inter alia: global organization(s) data (e.g. multiple jurisdictions data, local business environment data, geo political data, culturally diverse data, etc.); multiple stakeholders data (e.g. business line data, functions data, levels of experience data, third party data, contractor data, etc.); multiple risk category data (e.g. operational data, regulatory data, compliance data, privacy data, cybersecurity data, financial data, etc.); complex IT structure data (e.g. system data, application data, classification data, firewall data, vendor data, license data, etc.); etc. The risk identification, quantification, and mitigation engine can utilize data that is aggregated and analyzed to create real-time, collective, and predictive custom reports for different CXOs. The risk identification, quantification, and mitigation engine can generate risk board reports. The risk board reports include, inter alia: a custom, risk mitigation decision-making roadmap. In this regard, the risk identification, quantification, and mitigation engine can function as an ERM program, performing real-time, on demand enterprise-wide risk assessments. For example, the risk identification, quantification, and mitigation engine can be integrated across, inter alia: technical Infrastructure (e.g. cloud-computing providers); application systems (e.g. enterprise applications focused on customer service and marketing, analytics, and application development); company processes (e.g. audits, assessments, etc.); business performance tools (e.g. management, etc.), etc. Examples of risk identification, quantification, and mitigation Engine methods, use cases and systems are now discussed.

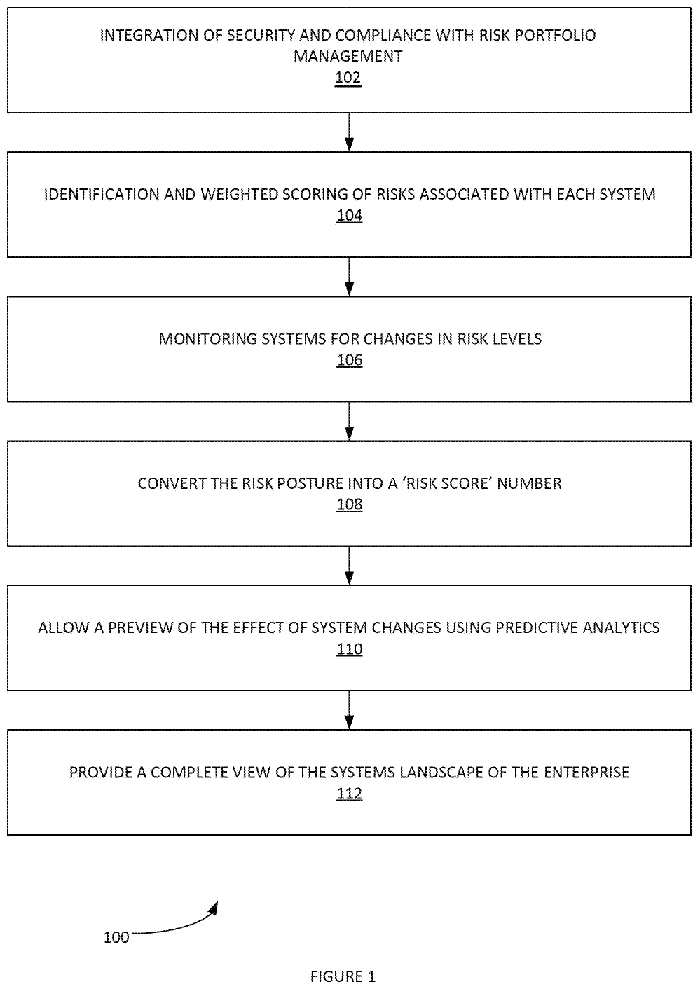

FIG. 1 illustrates an example process 100 for implementing risk identification, quantification, and mitigation engine delivery, according to some embodiments. Process 100 can enable an understanding of an enterprise's risk profile by providing a cross-organization risk assessment of current programs, risks, and resources. Process 100 can be used for risk mitigation. Process 100 can enable an enterprise to utilize AI and machine learning to understand their big data in real-time, thereby supporting the organization's business operations and objectives. Process 100 automation can be used to provide visibility into an enterprise's vertical businesses in real time (assuming for example, network and processing latencies). Additionally, enterprise stakeholders at all levels of an organization can use process 100 to identify important risk information specific to their individual roles and responsibilities in order to understand and optimize their risk profile. As noted, process 100 can utilize various data science algorithms and analytics, combined with AI and Machine Learning.

More specifically, in step 102, process 100 can implement the integration of security, privacy and compliance with a PPPM practice. In step 104, process 100 can calculate weighted value calculation of risks associated with each enterprise system. It is noted that if manual inputs are not provided, then the risk value can be automatically completed using various specified machine learning techniques. These machine learning techniques can match similar risk inputs with an associated weight.

In step 106, process 100 can monitor the relevant enterprise systems for changes in risk levels. In step 106, process 100 can convert the risk level into a risk-value number. The objective risk-value number can help avoid any subjective assessment or understanding of the risk.

In step 110, process 100 can allow a preview of the effect of system changes using predictive analytics. In step 112, process 100 can provide a complete portfolio management view of the organization's systems across the enterprise.

Process 100 can provide an aggregated view of changes to security, privacy, and compliance risk. Process 100 can provide a consolidated view of risk associated with different assets and processes in one place. Process 100 can provide risk value calculation and quantification. Process 100 can provide risk prediction. Process 100 can provide a CXO with a complete view of resource allocation and allow visibility into the various risk statuses and how all resources are aligned in real time.

### Example Systems

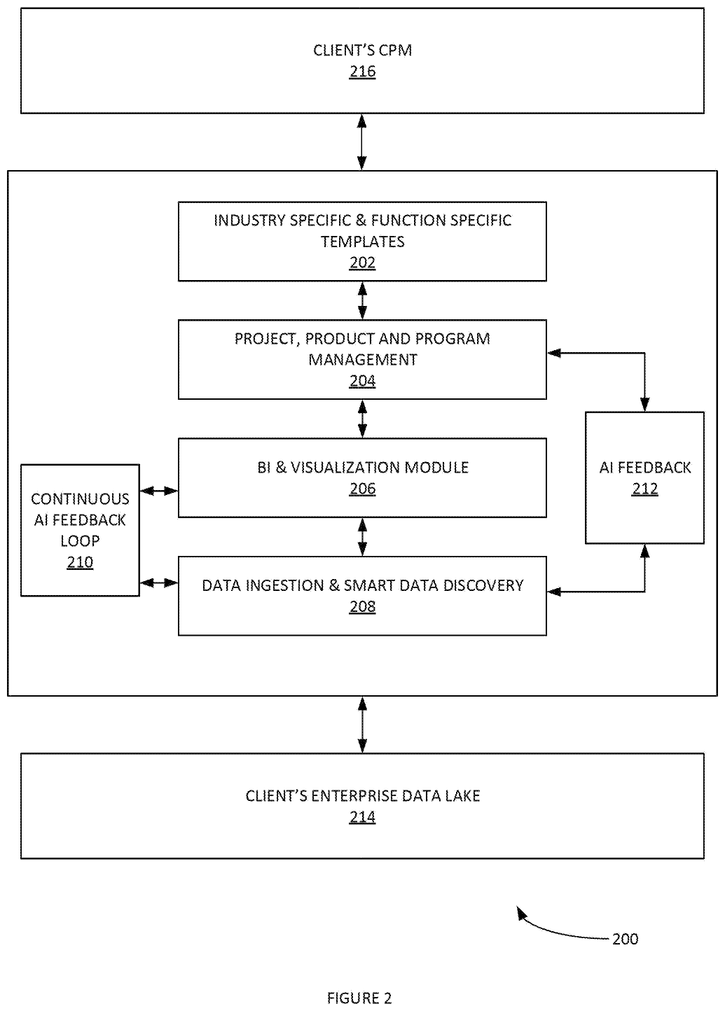

FIG. 2 illustrates an example risk identification, quantification, and mitigation engine delivery platform 200, according to some embodiments. Risk identification, quantification, and mitigation engine delivery platform 200 can include industry specific and function specific templates 202. The industry specific and risk specific templates 202 is a set of industry specific templates that have been created to define, identify, and manage the risk profiles of different industries. The list of target industries and associated compliance statutes can include, inter alia: financial services, pharmaceuticals, retail, insurance, and life sciences.

Furthermore, specified templates can include compliance templates. Compliance templates are created to calculate a risk value of the effectiveness of the controls established in a specified organization. The established controls are checked against the results of assessments performed by clients. Based on the client's inputs, the AI engine calculates the risk value by comparing the prior control effectiveness (impact and probability) to current control effectiveness. It is noted that the risk value of any control can be the decision indicator based on the risk severity. Risk severity can be provided at various levels. For example, risk severity levels can be defined as, inter alia: critical, high, medium, low, or very low.

Risk identification, quantification, and mitigation engine delivery platform 200 can include risk, product, and program management tool 204. Risk, product, and program management tool 204 can enable various user functionalities. Risk product and program management tool 204 can define a set of programs, risks, and products that are in-flight in the enterprise. Product and program management tool 204 can define the key stakeholders, risks, mitigation strategies against each of the projects, programs, and products. Project, product, and program management tool 204 can identify the high-level resources (e.g. personnel, systems, etc.) associated with the product, project, or program. Project, product, and program management tool 204 can provide the ability to define the changes in the enterprise system and therefore associate them to potential changes in risk and compliance posture.

Risk identification, quantification, and mitigation engine delivery platform 200 can include BI and visualization module 206. BI and visualization module 206 can provide a dashboard and/or other interactive modules/GUIs. BI and visualization module 206 can present the user with an easy to navigate risk management profile. The risk management profile can include the following examples, among others. BI and visualization module 206 can present a bird's eye view of the risks, based on the role of the user. BI and visualization module 206 can present the ability to drill into the factors contributing to the risk profile. BI and visualization module 206 can provide the ability to configure and visualize the risk as a risk value number using specified calculations. BI and visualization module 206 can provide the ability to adjust the weights for the various risks, with a view to perform what-if analysis. The BI and visualization module 206 can present a rich collection of data visualization elements for representing the risk state.

Risk identification, quantification, and mitigation engine delivery platform 200 can include data ingestion and smart data discovery engine 208. Data ingestion and smart data discovery engine 208 engine can facilitate the connection with external data sources (e.g. Salesforce.com, AWS, etc.) using various APIs interface(s) and ingest the data into the tool. Data ingestion and smart data discovery engine 208 engine can provide a definition of the key data elements in the data source that are relevant to risk calculation, that automatically matches the elements with expected elements in the system using AI. Data ingestion and smart data discovery engine 208 can provide the definition of the frequency with which data can be ingested.

It is noted that a continuous AI feedback loop 210 can be implemented between BI and visualization module 206 and data ingestion and smart data discovery engine 208. Additionally, AI feedback 212 can be implemented between project, product, and program management tool 204 and data ingestion and smart data discovery engine 208. Risk identification, quantification, and mitigation engine delivery platform 200 can include client's enterprise data applications and systems 214. Client's enterprise data applications and systems 214 can include CRM data, RDBMS data, project management data, service data, cloud-platform based data stores, etc.

Risk identification, quantification, and mitigation engine delivery platform 200 can provide the ability to track the effectiveness of the controls. Risk identification, quantification, and mitigation engine delivery platform 200 can provide the ability to capture status of control effectiveness at the central dashboard to enable the prioritization of decision actions enabled by AI value calculation engine (e.g. AI/ML engine 908, etc.). Risk identification, quantification, and mitigation engine delivery platform 200 can provide the ability to track the appropriate stakeholders based on the control's effectiveness for actionable accountability.

Risk identification, quantification, and mitigation engine delivery platform 200 can define a super administrator (e.g. ‘Super Admin’). The Super Admin can have complete root access to the application. In addition, a Super Admin can have complete access to an application with the exception of deletion permissions. In this version, the System Admin can define and manage all the risk models, users, configuration settings, automation etc.

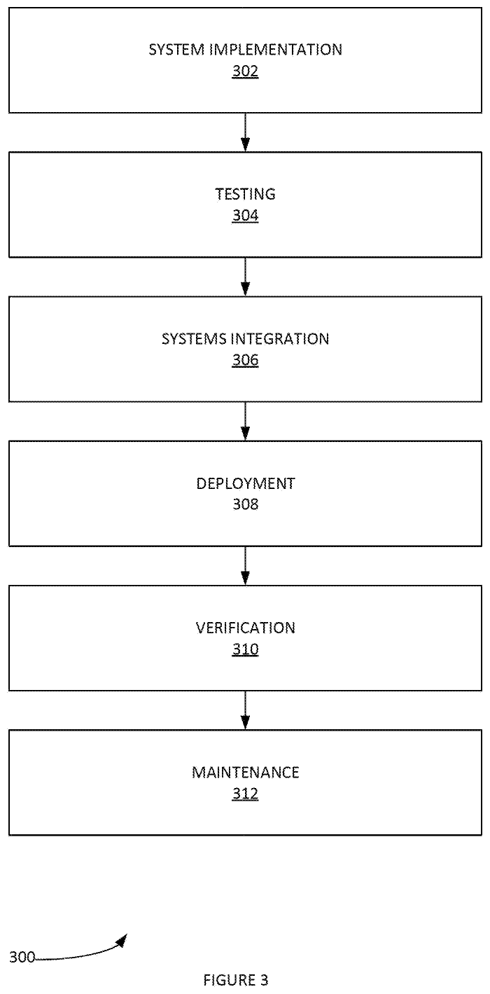

FIG. 3 illustrates an example process 300 for implementing risk identification, quantification, and mitigation engine delivery platform 200, according to some embodiments. In step 302, process 300 can perform System Implementation. More specifically, process 300 can, after implementing the system, define a super administrator. The super administrator can have the complete root access of the application. The super administrator may not be used for day-to-day operations in some examples. In one example, the process 300 can define a system administrator to complete access to the entire application, except deletion. In this way, system administrators can define and manage all the Risk Models, Users, Configuration Settings, Automation etc. Additional documentation can be provided as part of implementing the system.

In step 304, process 300 can perform testing operations. The risk identification, quantification, and mitigation engine delivery platform 200 can be tested in the non-production environment in the organization (e.g. staging environment) to ensure that the modules function as expected and that they do not create any adverse effect on the enterprise systems. Once verified, the system can be moved to the production environment.

In step 306, process 300 can implement client systems integration. The risk identification, quantification, and mitigation engine delivery platform 200 includes a standard set of APIs (e.g. connectors) to various external systems (e.g. AWS, Salesforce, Azure, Microsoft CRM). This set of APIs includes the ability to ingest the data from the external systems. The set of APIs are custom built and form a unique selling point of this system. Some organizations/entities have specified systems for which connectors are to be built. Once the connectors are built and deployed, the data from these systems can be fed into the internal engine and be part of the risk identification, monitoring and value calculation process.

In step 308, process 300 can perform deployment operations. Deployment of risk identification, quantification, and mitigation engine delivery platform 200 enables the organization/enterprise and the stakeholders to identify and place a value on the risk including the mitigation and management of the risk. The deployment process includes, inter alia, the following tasks. Process 300 can identify the environment in which the risk identification, quantification, and mitigation engine delivery platform 200 can be deployed. This can be a local environment within the De-Militarized Zone (DMZ) inside the protective segmentation and/or any external cloud environment like AWS or Azure. Process 300 can scope out the system related resources (e.g. web/application/database servers including the configuration settings). Process 300 can define the stakeholders (e.g. C-level executives, administrators, users etc.) with a specific focus on security and privacy needs and the roles to manage the application in the organization.

In step 310, process 300 can perform verification operations. Verification can be a part of validating the risk identification, quantification, and mitigation engine delivery platform 200 in the organization as it is deployed and implemented. In the verification process, the stakeholders orient themselves towards the risk's value (as opposed to providing subjective conclusions). This becomes a step in the overall success and adaptability of the application as inclusive as possible on a day-to-day basis.

In step 312, process 300 can perform maintenance operations. The technical maintenance of the system can include the step of monitoring the external connectors to ensure that the connectors are operating effectively. The step can also add new external systems according to the needs of the organization/enterprise. This can be completed using internal technical staff and staff assigned to the risk identification, quantification, and mitigation engine delivery platform 200, depending upon complexity and expertise level involved.

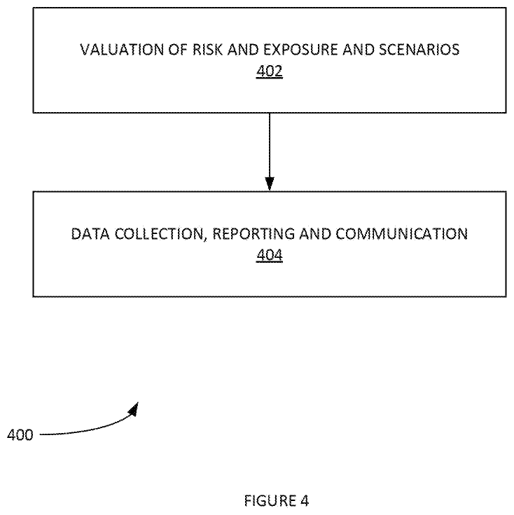

FIG. 4 illustrates an example risk assessment process 400, according to some embodiments. Process 400 can be used for accurate risk value calculation and determining financial exposure and remediation costs to an enterprise. Process 400 can combine multiple risk values to provide an aggregated view across the enterprise.

In step 402, process 400 can implement accurate calculation of risk exposure and scenarios. In one example, process 400 can use process 500 to implement accurate calculation of risk exposure and scenarios.

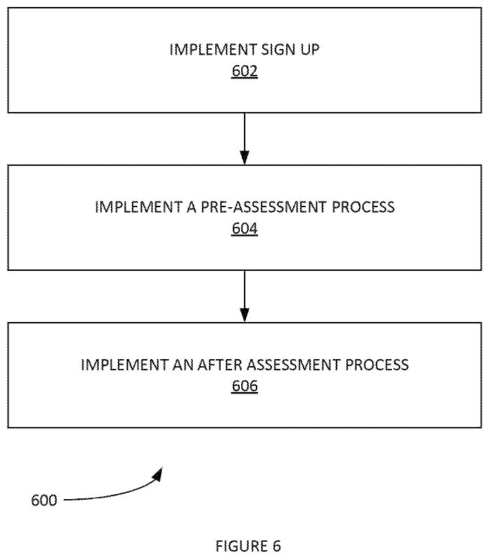

In step 502, process 400 can use process 600 to implement step 502. FIG. 6 illustrates an example of automatic risk value calculation process 600, according to some embodiments. Process 600 can calculate risk values. The risk values can determine the severity of the risk levels for an organization. Risk values can be calculated and displayed in a customizable format and with a frequency that meets a specific client's needs.

In step 602, process 600 can implement a sign-up process for a customer entity. When the customer signs up, process 600 can obtain various basic information about the industry that the customer entity operates in. Process 600 can also obtain, inter alia, revenue, employee population size details, regulations that are applicable, the operational IT systems and the like. Based on the data collected from other customers in the same industry and customer size, the risk value is arrived upon based on Machine Learning Algorithms that calculate a baseline for the industry (industry benchmarking).

In step 604, process 600 can implement a pre-assessment process(es). Based on the needs of the industry and/or for the entity (e.g. a company, educational institution, etc.), the customer selects controls that are to be assessed. Based on the customer's selection, process 500 can calculate a risk value. The risk value is based on, inter alia, a set of groupings of the risks which may have impact on the customer's security and data privacy profile. The collective impacts and likelihoods of the parts of the compliance assessments that are not selected can determine an upper level of the risk value. This can be based on pre-learned machine learning algorithms.

In step 606, process 600 can implement an after-assessment process(es). The after-assessment process(es) can relate to the impact of grouping of risks that create an exponential impact. The after-assessment process(es) can be based on the status of the assessment of the risk value. The after-assessment process(es) can be determined based on machine-learning algorithms that have been trained on data that exists on similar customer assessments.

Returning to process 500, in step 504, process 500 can implement a calculation of risk exposure assessment. It is noted that customers may wish to perform a cost-benefit analysis to assist with the decision to mitigate the risk using established processes. A dollar valuation of risk exposure provides a level of objectivity and justification for the expenses that the organization has to incur in order to mitigate the risk. Process 500 can use machine learning and existing heuristic data from organizations of similar size, industry and function and then extrapolate the data to determine the risk exposure, based on industry benchmarking, for the customer.

In step 506, process 500 can detect anomalies in risk values. The risk values are calculated according to the assessments-results for a given period. Process 500 can then make comparisons with the same week of a previous month and/or same month/quarter of a previous year. While doing the comparisons, the seasonality of risk can be considered along with its patterns as the risk may be just following a pattern even if it has varied widely from the last period of assessment. A machine learning algorithm (e.g. a Recurrent Neural Network (RNN), etc.) can be trained to detect these patterns and predict the approximate risk value that the user is expected to obtain during the upcoming assessments, according to the existing patterns in the data. The RNN can be trained on different types of patterns like sawtooth, impulse, trapezoid wave form and step sawtooth. Visualizations can display predicted versus actual values/scores and alert the users of anomalies.

In step 508, process 500 can implement risk scenario testing. In one example, risks that are being assessed may have some dependencies and triggers that may cause exponential exposures. It is noted that dependencies can exist between the risks once discovered. Accordingly, weights can be assigned to exposures based on the type of dependency. Exposures can be much higher based on additive, hierarchical or transitive dependencies. Process 500 calculates the highest possible risk exposures with all the risk scenarios and attracts the users' attention where the most attention is needed. Process 500 can automatically identify non-compliance in respect of certain controls and generates a list of possible scenarios based on the risk dependencies, then bubble up the most likely scenarios for the user to review.

Returning to process 400 in step 404, process 400 can implement data collection, reporting and communication. Process 400 can obtain data that is used for assessment that is generated by the customer's computing network/system as an output. These features help the user to optimize data collection with the lowest possibility of errors on the input side, and on the output, side provide the best possible reporting and communication capability. Process 400 can use process 700 to implement step 404.

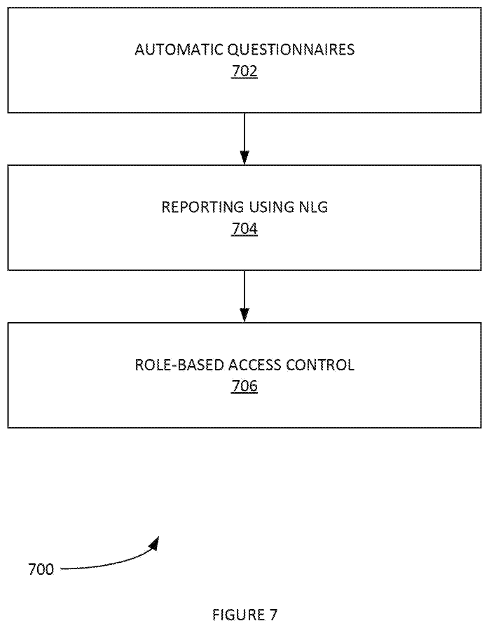

FIG. 7 illustrates an example data collection, reporting and communication process 700, according to some embodiments. In step 702, process 700 can create and implement automatic questionnaires. With the use of automatic questionnaires, any data in the customer system that is missing can be detected and flagged and, using NLG techniques, questions can be generated and sent in the form of a questionnaire that has to be filled in by the user/customer (e.g. a system administrator) to obtain the missing data required for risk value calculation.

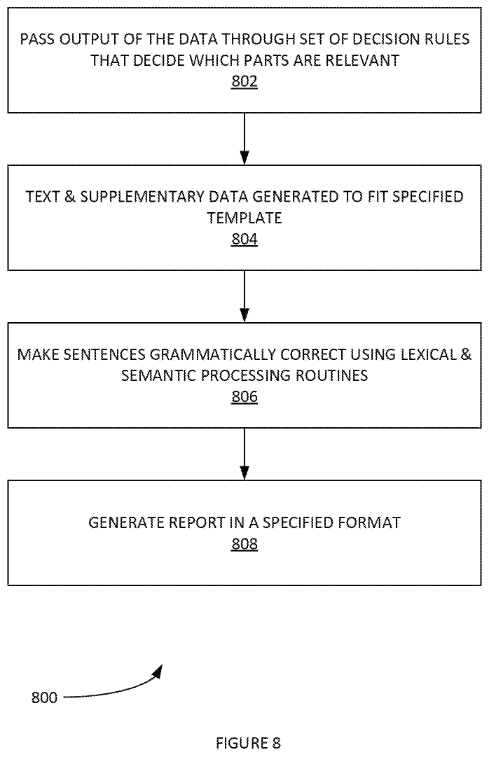

In step 704, process 700 can generate a report using NLG. It is noted that users may wish to obtain a snapshot of the data in a report format that can be used for communication in the organization at various levels. These reports can be automatically generated using a predetermined template for the report which is relevant to the client's industry. The report can be generated by process 800. FIG. 8 illustrates an example process 800 for generating a report using NLG, according to some embodiments.

In step 802, process 800 can use the output of the data. Process 800 can pass it through a set of decision rules that decide what parts of the report are relevant. In step 804, the text and supplementary data can be generated to fit a specified template. In step 806, process 800 can make the sentences grammatically correct using lexical and semantic processing routines. In step 808, the report can then be generated in any format (e.g. PDF, HTML, PowerPoint, etc.) as required by the user. The templates can be used to generate various dashboard views, such as those provided infra.

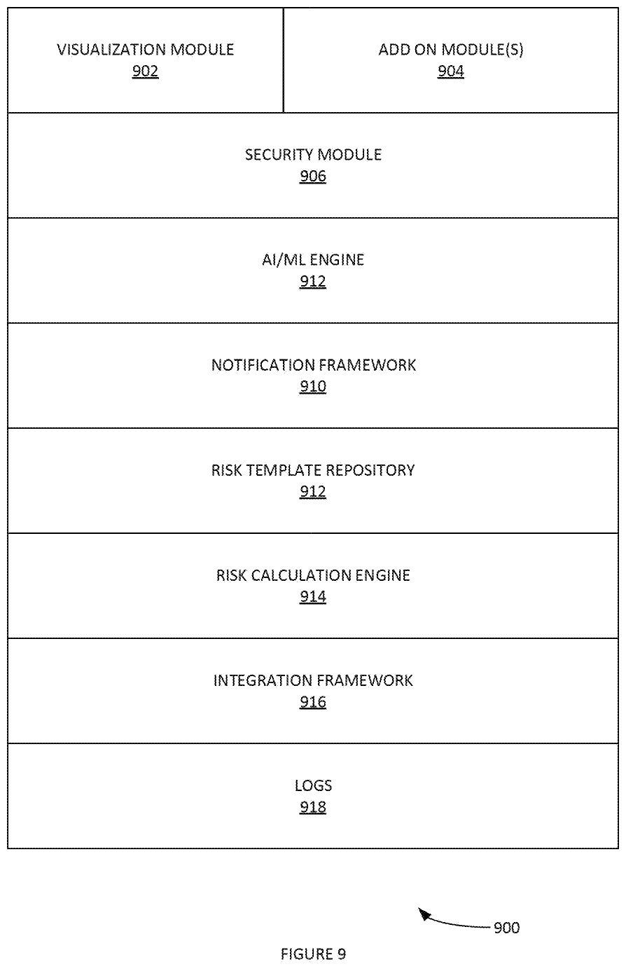

FIG. 9 illustrates additional information for implementing a risk identification, quantification, and mitigation engine delivery platform, according to some embodiments. As shown, a risk identification, quantification, and mitigation engine delivery platform 200 can be modularized with core capabilities and foundational components. These capabilities are available for all customers and initial license includes, inter alia: security, visualization, notification framework, AI/ML analytics-based predictive models, risk value calculation module, risk templates integration framework, etc. Risk identification, quantification, and mitigation engine delivery platform 200 can add various customizable risk models by category and/or industry that are relevant to the organization. These additional risk models can to the-core risk identification, quantification, and mitigation engine delivery platform 200 and/or can be licensed individually. These additional modules can be customized to a customer's requirements and needs.

As shown in the screen shots, risk identification, quantification, and mitigation engine delivery platform 200 provides a visual dashboard that highlights organizational risk based on defined risk models, for example compliance, system, security, and privacy. The dashboard allows users to aggregate and highlight risk as a risk value which can be drilled down for each of the models and then view risk at model level. As shown, users can also drill down into the model to view risk at a more granular detail.

Generally, in some example embodiments, risk identification, quantification, and mitigation engine delivery platform 200 can provide out of box connectivity with various products (e.g. Salesforce, Workday, ServiceNow, Splunk, AWS, Azure, GCP cloud providers, etc.), as well as ability to connect with any database or product with minor customization. Risk identification, quantification, and mitigation engine delivery platform 200 can consume the output of data profiling products or can leverage DLP for data profiling. Risk identification, quantification, and mitigation engine delivery platform 200 has a customizable notification framework which can proactively monitor the integrating systems to identify anomalies and alert the organization. Risk identification, quantification, and mitigation engine delivery platform 200 can track the lifecycle of the risk for the last twelve (12) months. Risk identification, quantification, and mitigation engine delivery platform 200 has AI/ML capabilities (e.g. see AI/ML engine 908 infra) to predict and highlight risk as a four (4) dimensional model based on twelve (12) month aggregate. The dimensions can be measured by color, size of bubble (e.g. importance and impact to organization/enterprises), cost to fix and risk definition.

Risk identification, quantification, and mitigation engine delivery platform 200 includes an alerting and notification framework that can customize messages and recipients.

Risk identification, quantification, and mitigation engine delivery platform 200 can include various addons as noted supra. These addons (e.g. inventory trackers for retailers, controlled substance tracker for healthcare organizations, PII tracker, CCPA tracker, GDPR tracker) can integrate with common framework and are managed through common interface.

Risk identification, quantification, and mitigation engine delivery platform 200 can proactively monitor the organization at a user-defined frequency. Risk identification, quantification, and mitigation engine delivery platform 200 has the ability to suppress risk based on user feedback. Risk identification, quantification, and mitigation engine delivery platform 200 can integrate with inventory and order systems. Risk identification, quantification, and mitigation engine delivery platform 200 contains system logs. Risk identification, quantification, and mitigation engine delivery platform 200 can define rules by supported by Excel Templates. Risk identification, quantification, and mitigation engine delivery platform 200 can include various risk models that are extendable and customizable by the organization.

More specifically, FIG. 9 illustrates a risk identification, quantification, and mitigation engine delivery platform 200 with modularized-core capabilities and components 900, according to some embodiments. Modularized-core capabilities and components 900 can be implemented in risk identification, quantification, and mitigation engine delivery platform 200. Modularized-core capabilities and components 900 can include a customizable compliance AI tool (e.g. AI/ML engine 208, etc.). Modularized-core capabilities and components 900 can include PCI DSS controls applicable for organizations. Modularized-core capabilities and components 900 can also include GDPR controls, HIPAA controls, ISMS (includes ISO27001) controls, SOC2 controls, NIST controls, CCPA controls, etc. The use of these controls can be based on the various relevant applications for the customer(s). Modularized-core capabilities and components 900 can include a processing engine to obtain the status from organizations. Modularized-core capabilities and components 900 can provide a dashboard enabling the compliance stakeholders to take action based on the risk value (e.g. see visualization module 204 infra). These controls can be based on the various relevant applications for the customer(s). Modularized-core capabilities and components 900 can include a processing engine to obtain the status from organizations.

Modularized-core capabilities and components 900 can include a visualization module 902. Visualization module 902 can generate and manage the various dashboard view (e.g. such as those provided infra). Visualization module 902 can use data obtained from the various other modules of FIG. 9, as well as applicable systems in risk identification, quantification, and mitigation engine delivery platform 200. The dashboard can enable stakeholders to take action based on the risk value.

Add-on module(s) 904 can include various modules (e.g. CCPA Module, PCI module, GDPR module, HIPPA module, retail inventory module, FCRA module, etc.).

Security module 906 provides an analysis of a customer's system and network security systems, weaknesses, potential weaknesses, etc.

AI/ML engine 908 can present a unique risk value for the controls based on the historical data. AI/ML engine 908 can provide AI/ML Analytics based predictive models of risk identification, quantification, and mitigation engine delivery platform 200. For example, AI/ML 908 can present a unique risk value for the controls based on the historical data.

Notification Framework 910 generates notifications and other communications for the customer. Notification Framework 910 can create questionnaires automatically based on missing data. Notification Framework 910 can create risk reports automatically using Natural Language Generation (NLG). The output of Notification Framework 910 can be provided to visualization module 902 for inclusion in a dashboard view as well.

Risk Template Repository 912 can include function specific templates 202 and/or any other specified templates described herein.

Risk calculation engine 914 can take inputs from multiple disparate sources, intelligently analyze, and present the organizational risk exposure from the sources as a numerical value/score using specified calculations (e.g. a hierarchy using pre-learned algorithms in a ML context, etc.). Risk calculation engine 914 can perform automatic risk value calculation after customer sign-up. Risk calculation engine 914 can perform automatic risk value calculation before and after an assessment as well. Risk calculation engine 914 can calculate the monetary valuation of a risk exposure after the assessment process. Risk calculation engine 914 can provide a default risk profile set-up for an organization based on their industry and stated risk tolerance. Risk calculation engine 914 can detect anomalies in risk values for a particular period assessed. Risk calculation engine 914 can provide a list of risk scenarios which can have an exponential impact based.

Integration Framework 916 can provide and manage the integration of security and compliance with a customer's portfolio management.

Logs 918 can include various logs relevant to customer system and network status, the operations of risk identification, quantification, and mitigation engine delivery platform 200 and/or any other relevant systems discussed herein.

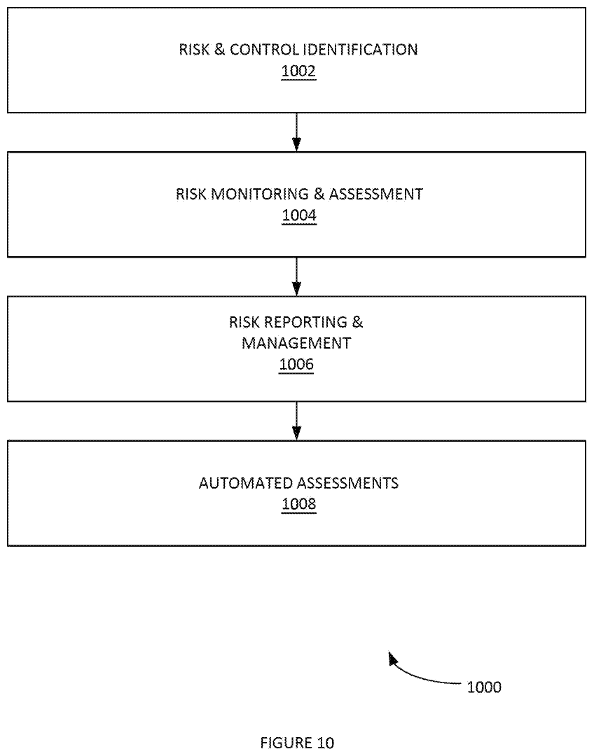

FIG. 10 illustrates an example process 1000 for enterprise risk analysis, according to some embodiments. In step 1002, process 1000 can implement risk and control identification. Risks and controls can be categorized by, inter alia: risk type, function, location, segment, etc. Owners and stakeholders can be identified. This can include identifying relevant COSO standards. This can include identifying and quantifying, inter alia: impact, likelihood of exposure in terms of cost, remediation cost, etc.

In step 1004, process 1000 can implement risk monitoring and assessment. Process 1000 can provide and implement various automated/manual standardized templates and/or questionnaires. Process 1000 can implement anytime on-demand alerts for pending/overdue assessments as well.

In step 1006, process 1000 can implement risk reporting and management. For example, process 1000 can provide a risk value calculation, risk analytics dashboard, customizable widgets alerts and notifications. These can include various AI/ML capabilities.

In step 1008, process 1000 can generate automated assessments (e.g. of system/cybersecurity risk, AWS®, GCP®, VMWARE®, AZURE®, SFDC®, SERVICE NOW®, SPLUNK® etc.). This can also include various privacy assessments (e.g. GDPR-PII, CCPA-PII, PCI-DSS-PII, ISO27001-PII, HIPAA-PII, etc.). Operational risk assessment can be implemented as well (e.g. ARCHER®, ServiceNow®, etc.). Process 1000 can review COMPLIANCE (E.g. GDPR, CCPA, PCI-DSS, ISO27001, HIPAA, etc.). Manual assessments can also be used to validate/supplement automated assessments.

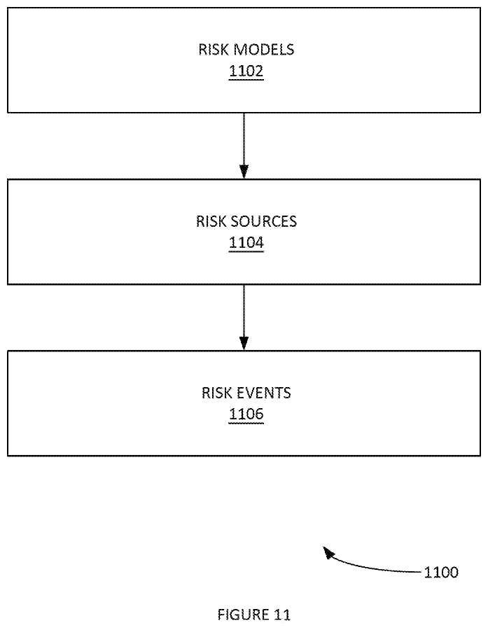

FIG. 11 illustrates an example process 1100 for implementing a risk architecture, according to some embodiments. In step 1102, process 1100 can generate risk models. This can provide a quantitative view of an organization's enterprise level risk categorization.

In step 1104, process 1100 provides a list of risk sources. These can be any items exposing an enterprise to risk. In step 1106, process 1100 can provide risk events. This can include monitoring and identification of risk.

### Agent System for Hardware Risk Information

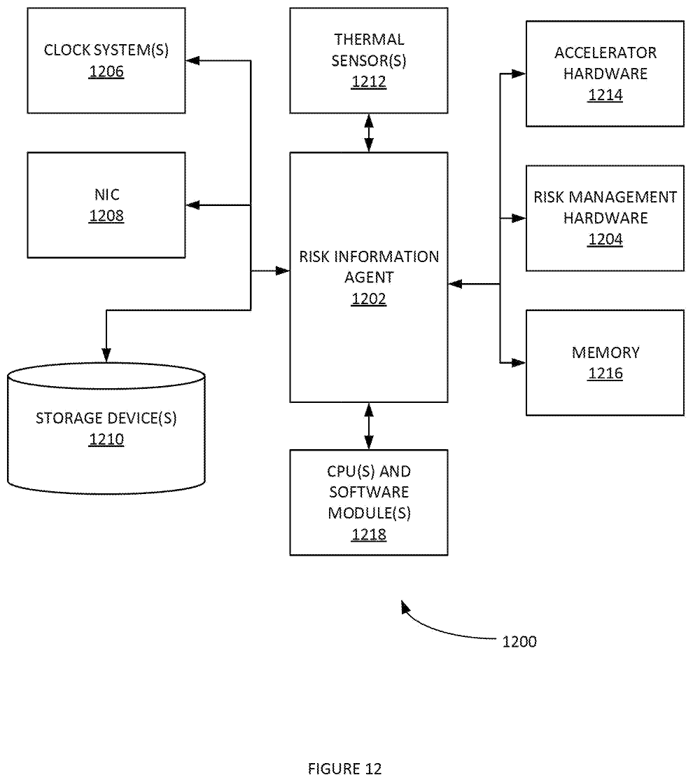

FIG. 12 illustrates an example hardware risk information system 1200 for implementing an agent system for hardware risk information, according to some embodiments. Hardware risk information system 1200 identifies risk by tracking the hardware assets that have been deployed by an enterprise. For example, hardware risk information system 1200 can track the following hardware asset variables. Hardware risk information system 1200 can track time since the enterprise asset was switched on. Hardware risk information system 1200 can track continuous usage of the enterprise asset. Hardware risk information system 1200 can track the number of restarts of the hardware system(s) of the enterprise asset. Hardware risk information system 1200 can track the physical/thermal conditioning of the enterprise asset. Hardware risk information system 1200 can track specified software/data assets that are dependent on the hardware asset as well.

FIG. 12 illustrates an example of hardware risk information system 1200 utilizing a local risk information agent 1202. Local risk information agent 1202 runs on the hardware systems of the enterprise assets. Local risk information agent 1202 manages the collection of the information necessary to calculate the risk value discussed supra.

Local risk information agent 1202 collects this information from various specified hardware sources operative in the enterprise assets. For example, local risk information agent 1202 collects clock related information from clock system(s) 1106. Local risk information agent 1202 can collect current time to calculate the time since switch-on and/or time since last restart and the like from a real-time clock.

Local risk information agent 1202 can collect information from the NIC 1108. For example, local risk information agent 1202 can obtain statistics on the usage of various computer network(s), network traffic spikes and/or any other changes in the network traffic going in and out of the hardware asset being monitored.

Local risk information agent 1202 can collect information from various enterprise assets data storage system(s) 1110 (e.g. hard drive, SSD systems, other data storage systems, etc.). Local risk information agent 1202 can collect usage statistics of the data based on how much the enterprise asset is accessing the data storage 1110 on the enterprise asset.

Local risk information agent 1202 can collect information from an accelerator hardware system(s) 1114. Local risk information agent 1202 can collect information about acceleration of certain software functions including, inter alia: machine learning functions, graphic functions, etc. Local risk information agent 1202 can use special-purpose hardware that is attached to the enterprise asset.

Local risk information agent 1202 can collect information from memory systems 1116. It is noted that high memory usage can signal the extreme usage of a hardware asset.

Local risk information agent 1202 can collect information from CPU and software modules 1118 of the enterprise assets. High CPU usage may also signify extreme usage of relevant elements of the hardware systems of the enterprise asset. Local risk information agent 1202 can collect information from specified software modules and their associated criticality information. Local risk information agent 1202 can collect information from thermal sensors that may have an important role in finding how fast the modules may degrade.

Local risk information agent 1202 can utilize risk management hardware device 1204 for analyzing the collected information. After collecting the risk information from the enterprise asset's hardware and on a specified basis (e.g. at a specified period), local risk information agent 1202 agent pushes the collected information onto risk management hardware device 1204. Risk management hardware device 1204 serves as a repository for all the risk parameters for the enterprise asset.

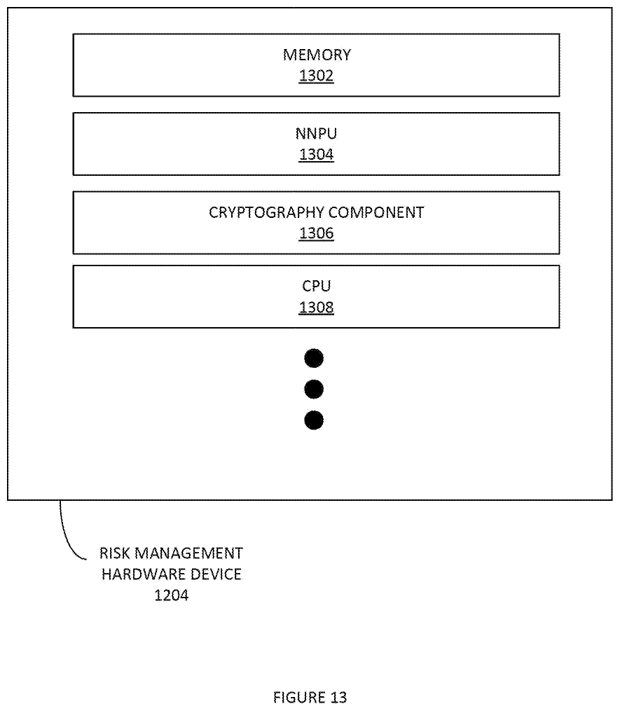

FIG. 13 illustrates an example risk management hardware device 1204 according to some embodiments. Risk management hardware device 1204 includes a memory 1302. Memory 1302 can be persistent for storing the risk parameters stored for the long term. Risk management hardware device 1204 includes a low-power Neural Network Processing Unit (NNPU) 1304. NNPU 1304 can be used for local AIML processing and summarization operations. These can include various processes provided supra.

Risk management hardware device 1204 can include a cryptography component 1306. Cryptography component 1306 can be utilized for securing the data using encryption while sending the collected data and/or any analysis performed by risk management hardware device 1204 into and out of the risk management hardware device 1204.

Risk management hardware device 1204 can include a lightweight CPU 1308. CPU 1308 can run instructions for all tasks performed locally on risk management hardware device 1204. These tasks can include, inter alia: data copies, IO with the NNPU, the cryptographic component and memory, etc.

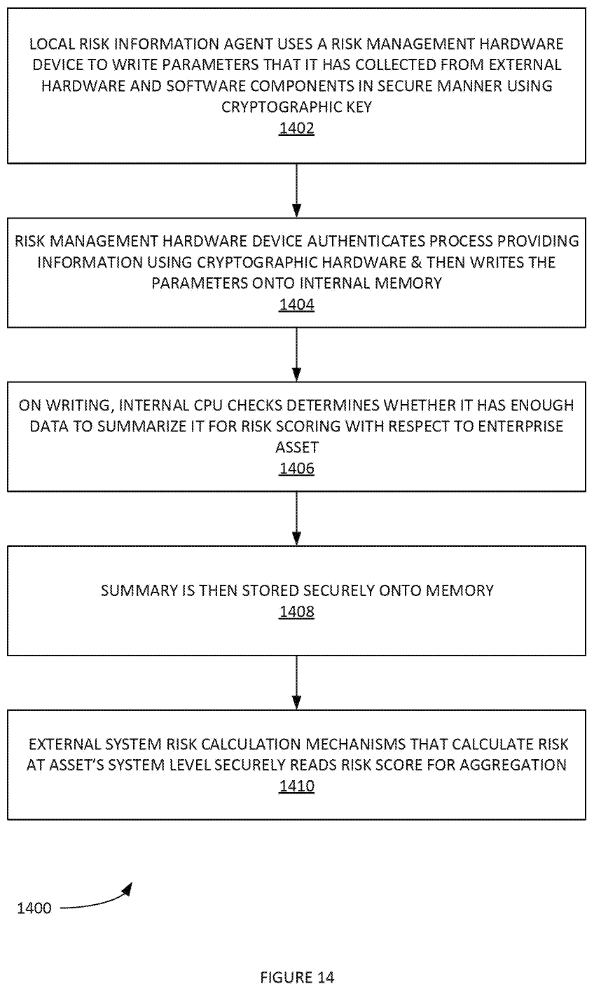

FIG. 14 illustrates an example process 1400 for using a risk management hardware device for calculating the risk value of an enterprise asset, according to some embodiments. In step 1402, on a periodic basis, a local risk information agent (e.g. local risk information agent 1202) uses a risk management hardware device to write the parameters that it has collected from the external hardware and software components in a secure manner using the cryptographic key supplied to it. In step 1404, the risk management hardware device authenticates the process providing the information using the cryptographic hardware and then writes the parameters onto the internal memory. In step 1406, on writing, the internal CPU checks determines whether it has enough data to summarize it for risk value calculation with respect to the enterprise asset. If ‘yes,’ then the risk management hardware device sends the data to the NNPU for creating a risk value based on the current chunk of data and the older risk values. In step 1408, the summary is then stored securely onto memory. In step 1410, the external system risk calculation mechanisms that calculate risk at the asset's system level can now securely read this risk value for aggregation.

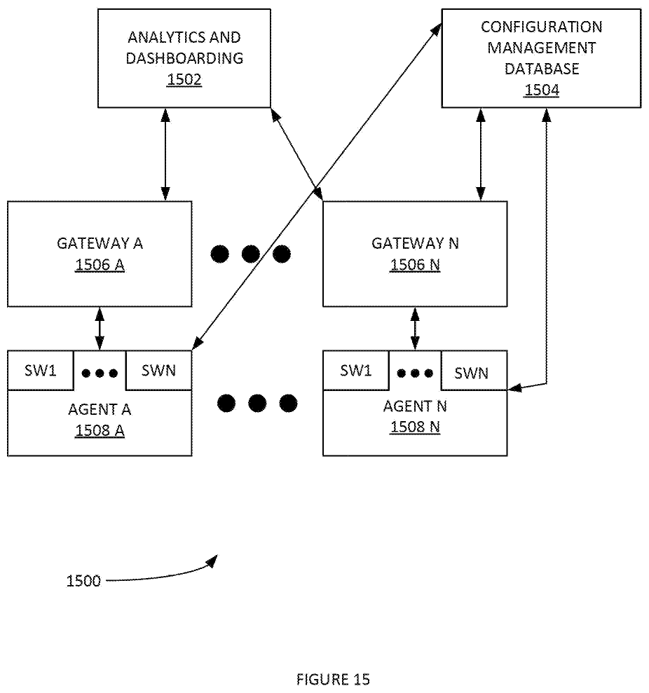

FIG. 15 illustrates a system of Risk Management Software Architecture 1500 according to some embodiments. Agents 1508 A-N can sit on the hardware components of a set of enterprise assets. Agents 1508 A-N are installed on all the machines in the enterprise asset to summarize all the risk parameter information onto the risk management hardware device 1204.

Gateways 1506 A-N can collect the risk values for a portion of the enterprise architecture from the agents attached to the hardware components. Gateways 1506 A-N can summarize this information and present it to Analysis and Dashboarding component 1502. Gateways 1506 A-N can collect the information that is stored on through the agents and combine this information with the map of all the software components using a Configuration Management DataBase (CMDB) 1504 and have a combined Risk Map. The Risk Map is then read by Analytics and Dashboarding.

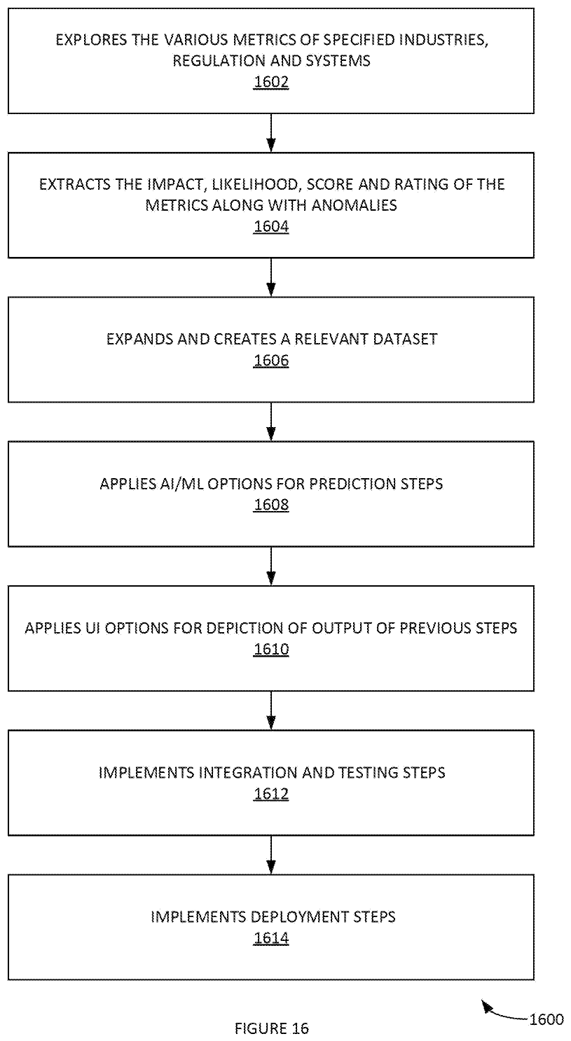

Analysis and Dashboarding component 1502 can summarize risk data in a user interface and use API(s) to present various value calculation, exposure, remediation, trends, and progression of the entire enterprise by collecting data from all the agents and gateways. Analysis and Dashboarding component 1502 can use a specified AI/ML algorithm to optimize analysis and presentation of the information. Analytics and Dashboarding component 1502 can provide users insights based on the data collected from the manual and electronic components of system 1500. The dashboard uses the following shallow learning (e.g. with deep-learning topologies) in neural networks for dashboarding as provided in FIGS. 16-26. Accordingly FIGS. 16-26 illustrate example processes implemented using neural networks for dashboarding, according to some embodiments.

FIG. 16 illustrates an example process 1600 implementing automated risk value calculation, risk exposure, and risk re-mediation costs according to some embodiments. The automated risk value calculation uses advanced machine learning techniques to arrive at the risk value from the control data that is gathered from IT plant (networks, servers, devices etc.), and from questionnaires that are being assessed for that company. The AI/ML model uses a combination of inbuilt combinations (that may elevate the risk levels) and triggering risk categories to come up with the summary risk values per category of risk and for the higher-level risk value for the company. The automated risk value calculation system learns the rules directly from the data and uses it to value/score future assessments.

More specifically, in step 1602, process 1600 explores the various metrics of specified industries, regulations and systems and selects the right set of AI/ML modules that would be relevant. In step 1604, process 1600 derives the impact, likelihood, and risk value of the metrics along with anomalies. In step 1608, process 1600, applies AI/ML options for prediction steps. In step 1610, process 1600 applies UI options for depiction of output of previous steps. In step 1612, process 1600 implements integration and testing steps. In step 1614, process 1600 implements deployment steps. The summarization for various risk categories and the highest-level risk value for the company is also generated.

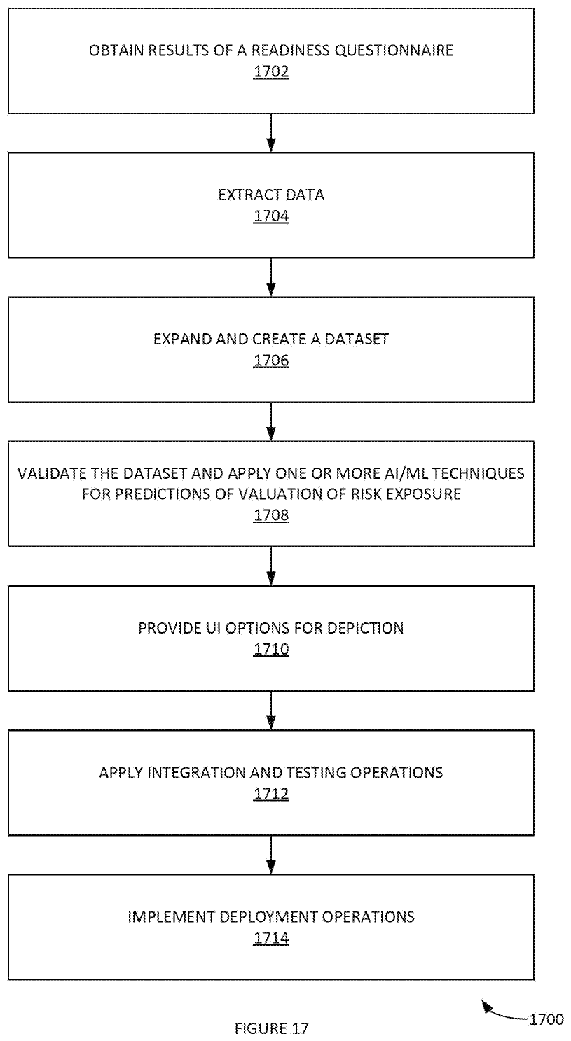

FIG. 17 illustrates an example process 1700 for determining a valuation of risk exposure, according to some embodiments. With a company's revenue, number of employees, number of systems, applications, devices, and other company size parameters along with, risk tolerance and risk value of the company using the present system can be able to predict the risk exposure of the company using AI/ML techniques.

More specifically, in step 1702, process 1700 can provide and obtain results of a readiness questionnaire. In step 1704, process 1700 can extract data related to, inter alia: control, severity, cumulations, USD exposure range, etc. In step 1706, process 1700 expands and creates a dataset (e.g. data set obtained from readiness questionnaires, etc.). In step 1708, process 1700 can validate the dataset and apply one or more AI/ML techniques for predictions of valuation of risk exposure. In step 1710, process 1700 can provide UI options for depiction. In step 1712, process 1700 can apply integration and testing operations. In step 1714, process 1700 implements deployment operations.

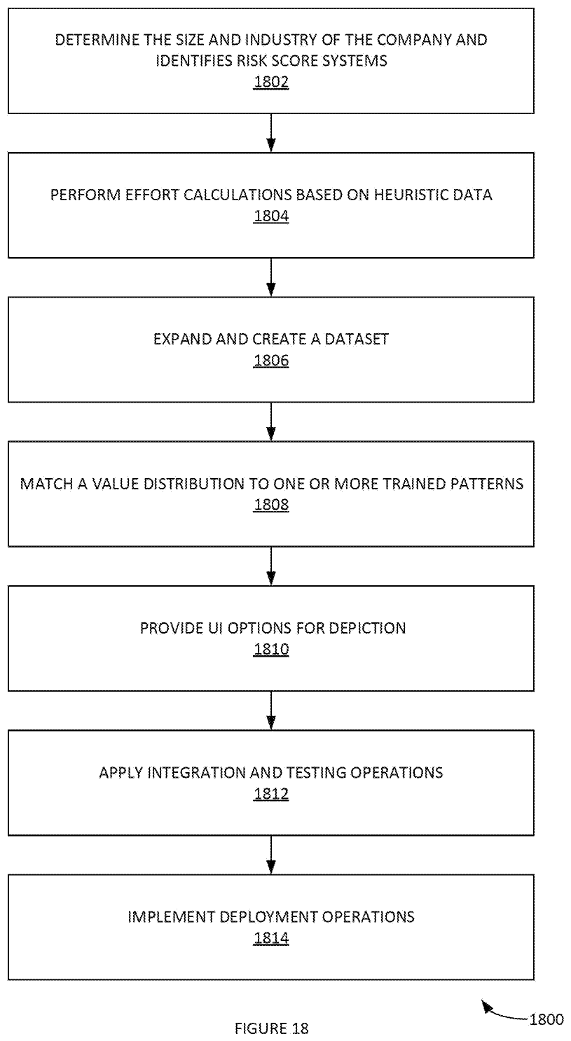

FIG. 18 illustrates an example process 1800 for determining a risk remediation cost, according to some embodiments. The risk remediation cost analysis combines the experience of industry professionals, in addition to revenue, number of employees, number of systems, risk tolerance of the company and other company size parameters. Hardware risk information system 1200 can use AI/ML algorithms to combine these to generate/calculate the final risk remediation costs.

More specifically, in step 1802, process 1800 determines the size and industry of the company and identifies risk value systems. In step 1804, process 1800 performs effort calculations based on heuristic data. This data is sent to step 1806, that expands and creates a dataset. In step 1808, process 1800 matches a value distribution to one or more trained patterns. In step 1810, process 1800 can provide UI options for depiction. In step 1812, process 1800 can apply integration and testing operations. In step 1814, process 1800 implements deployment operations.

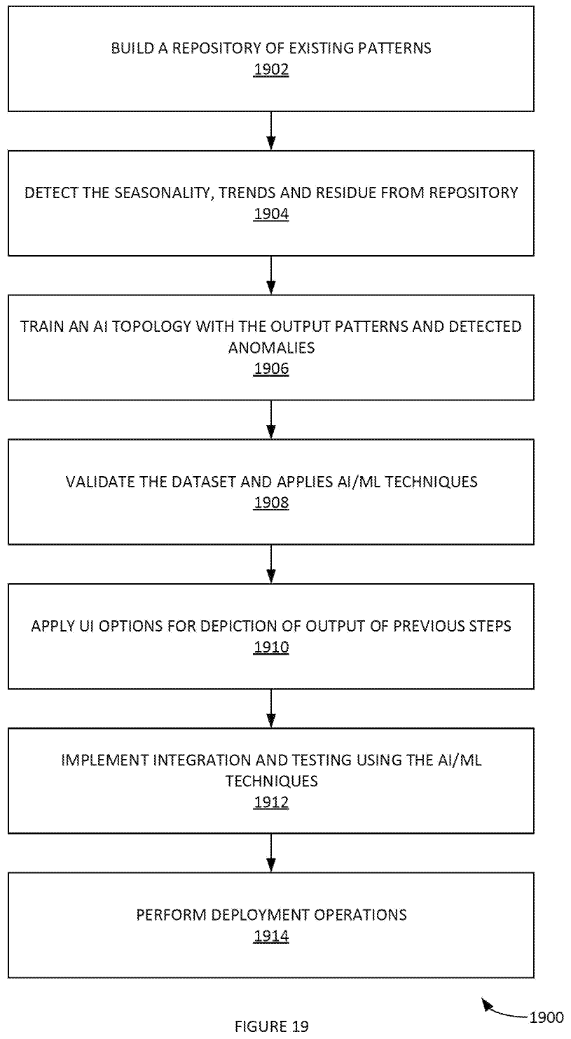

FIG. 19 illustrates an example process 1900 for anomaly detection in risk values, according to some embodiments. Hardware risk information system 1200 can use trend analysis and detection of risk values by using AI/ML algorithms to predict the risk values for the future months. A drastic difference may lead to alerts triggered in the system.

More specifically, in step 1902, process 1900 builds a repository of existing patterns. In step 1904, process 1900 detects the seasonality, trends, and residue from the repository. This step can also detect anomalies. In step 1906, process 1900 trains an AI topology with the output patterns and detected anomalies of step 1904. In step 1908, process 1900 validates the dataset and applies AI/ML techniques. In step 1910, process 1900 applies UI options for depiction of output of previous steps. In step 1912, process 1900 implements integration and testing using the AI/ML techniques. In step 1914, process 1900 performs deployment operations.

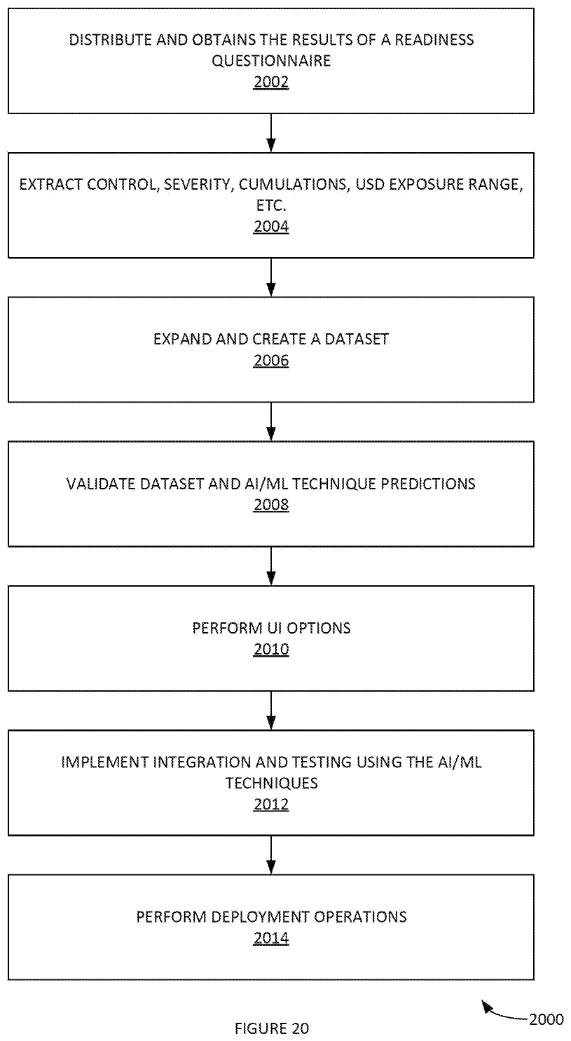

FIG. 20 illustrates an example process 2000 for industry benchmarking, according to some embodiments. Hardware risk information system 1200 can use industry benchmarks that are summarized by AI/ML algorithms. Hardware risk information system 1200 can use data that is spanning all industries, with companies of various sizes.

In step 2002, process 2000 distributes and obtains the results of a readiness questionnaire. In step 2004, process 2000 extracts control, severity, cumulations, USD exposure range, etc. from input to readiness questionnaire. In step 2006, process 2000 expands and creates a dataset (e.g. dataset generated from previous steps and/or other processes discussed herein, etc.). In step 2008, process 2000 validates dataset and AI/ML technique predictions. In step 2010, process 2000 performs UI options for depiction of output of previous steps. In step 2012, process 2000 performs integration and testing. In step 2014, process 2000 performs deployment operations.

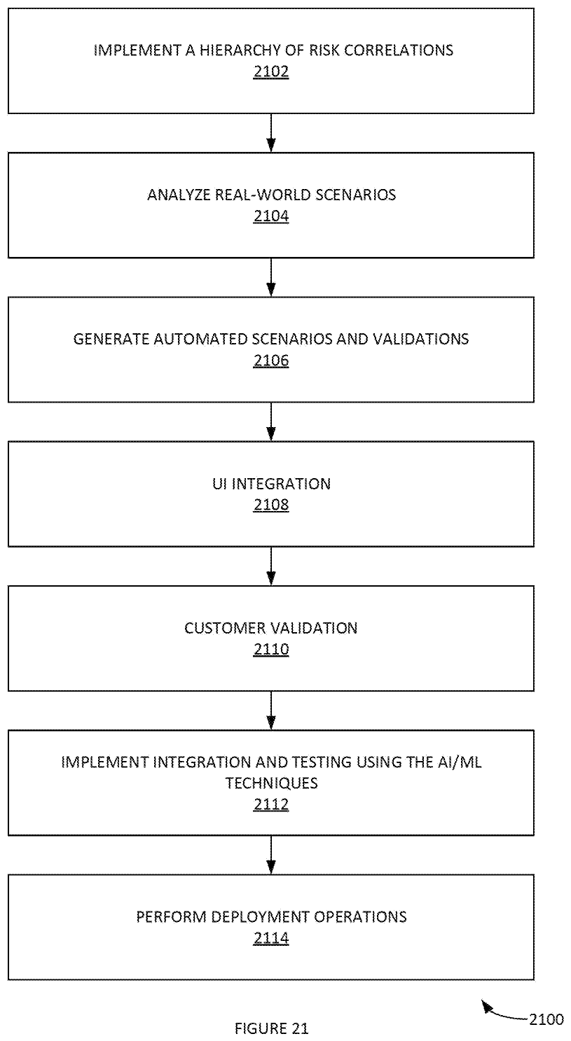

FIG. 21 illustrates an example process 2100 for risk scenario testing, according to some embodiments. Hardware risk information system 1200 can utilize knowledge of risks that are interdependent and may trigger each other. For example, a network risk may put an application at risk, and this may create a data risk that may lead to a breach that is an operational risk and finally it may cause a risk to the brand image. The entire system of risk and their dependencies and what if scenarios can be created that can test if the system is resilient and the right sentinels for risk are placed in the system.

More specifically, in step 2102, process 2100 implements a hierarchy of risk correlations. In step 2104, process 2100 analyzes real-world scenarios. In step 2106, process 2100 generates automated scenarios and validations. UI integration is implemented in step 2108. Customer validation is implemented in step 2110. In step 2112, process 2100 applies integration and testing. In step 2114, process 2100 performs deployment operations.

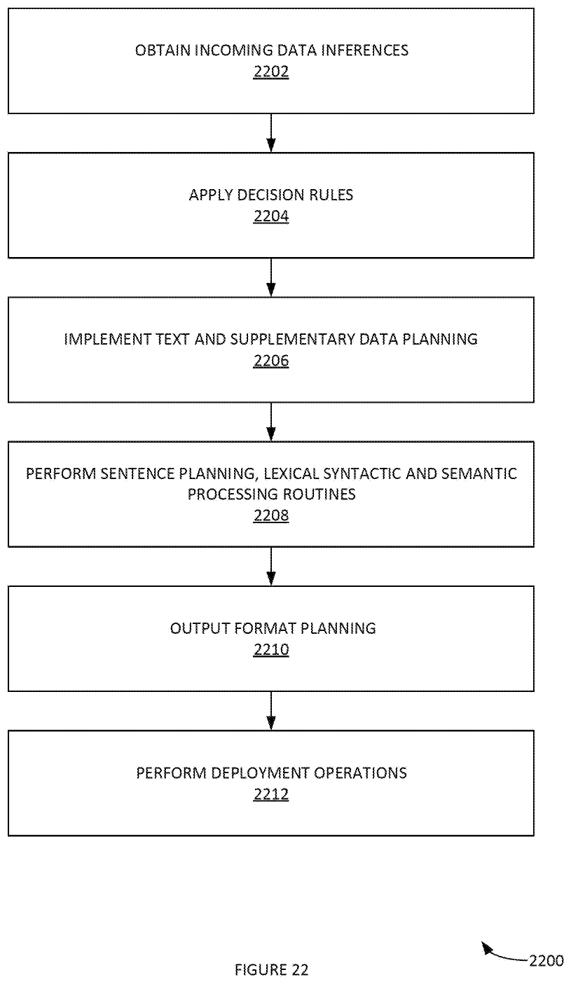

FIG. 22 illustrates an example process 2200 implemented using automatic questionnaires and NLG, according to some embodiments. After the assessments are completed, there may be certain gaps in the data to come up with the risk values, risk exposure and risk remediation costs. Using NLG techniques, questions are created that fill gaps, if any. The questions may then be sent to the appropriate personnel for completion.

More specifically in step 2202, incoming data inferences are obtained. In step 2204, process 2200 applies decision rules. Text and supplementary data planning are implemented in step 2206. In step 2208, process 2200 performs sentence planning, lexical syntactic and semantic processing routines. In step 2210, output format planning is implemented. In step 2212, process 2200 performs deployment operations.

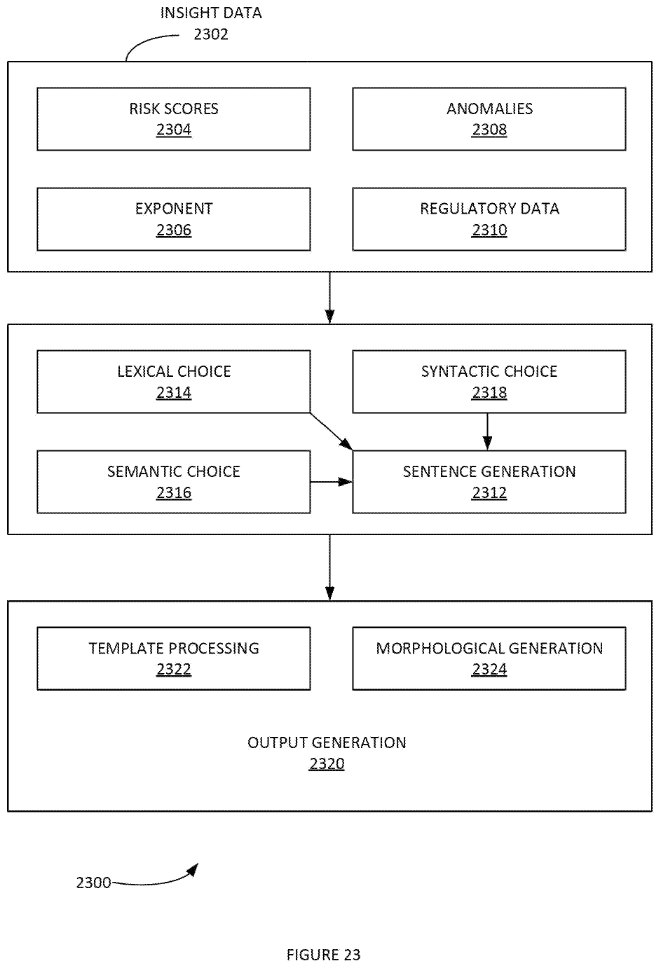

FIG. 23 illustrates an example process 2300 implemented using reporting using NLG, according to some embodiments. A report is generated (e.g. by hardware risk information system 1200) for senior executives, auditors and other stakeholders setting out risk results. For coming up with a natural language report using the insights that is generated by the system, templates may be used to turn the insights into actionable recommendations in a report. This is achieved by using artificial intelligence-based NLG techniques hardware risk information system 1200 can use the insights, and the templates and generate a human readable report. Process 2300 can report output of 2200 using NLG operations.

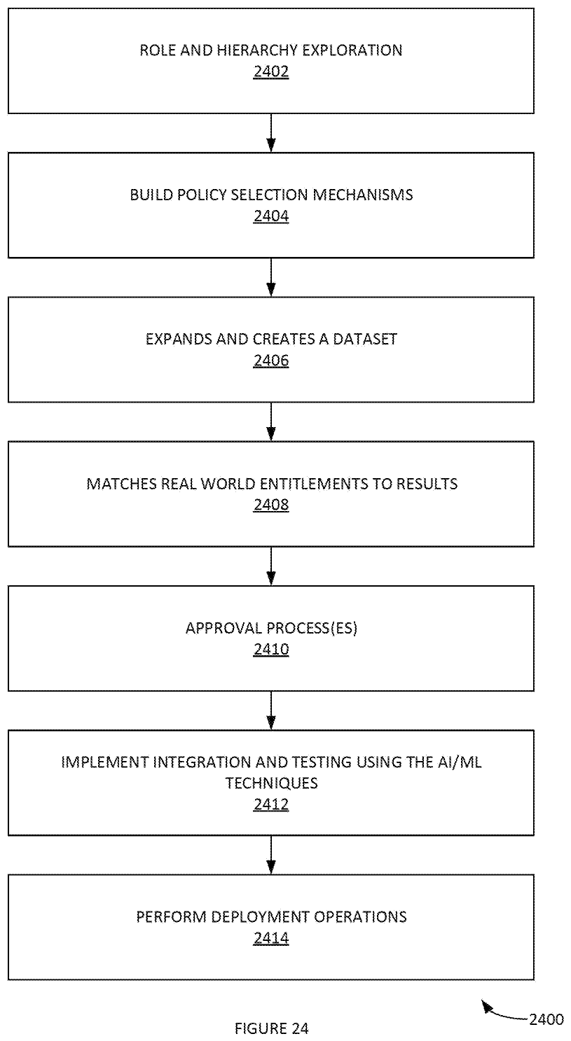

FIG. 24 illustrates an example process 2400 of automatic role assignment for role-based access control, according to some embodiments. The hierarchies in between the CXO organizations may be very different in companies. Accordingly, an automatic way to provide a role-based access control can be to use the hierarchies and using correlation techniques in artificial intelligence to provide roles for users of the system based on their hierarchies.

In step 2402, process 2400 implements role and hierarchy exploration. In step 2404, process 2400 builds policy selection mechanisms. In step 2406, process 2400 expands and creates a dataset from the outputs of step 2402 and 2404. In step 2408, process 2400 matches real world entitlements to results. Approval process(es) are deployed in step 2410. In step 2412, process 2400 applies integration and testing. In step 2414, process 2400 performs deployment operations.

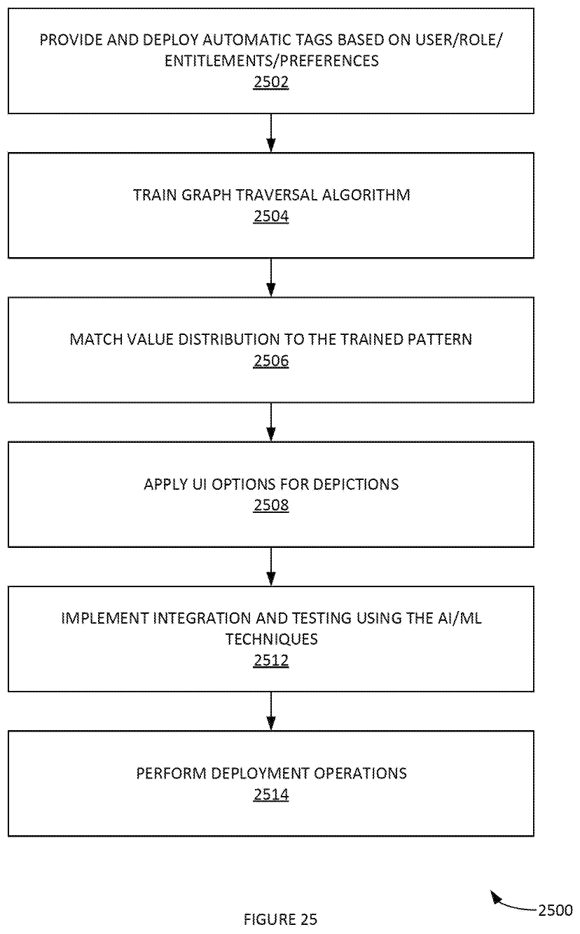

FIG. 25 illustrates an example process 2500 implemented using intelligence for adding risk value calculation, according to some embodiments. Risk-based parameters to be entered into hardware risk information system 1200 may be present. However, in case some new controls are to be created, intelligence is provided by using all the data, categories, threats, and vulnerabilities that are there in the system to come up with any new control that is entered by the user. This is done a priori search algorithms that use machine learning. Also, hardware risk information system 1200 can automatically create dashboards and UI elements based on usage of the user.

In step 2502, process 2500 provides and deploys automatic tags based on user/role/entitlements/preferences. In step 2504, process 2500 trains graph traversal algorithm. In step 2506, process 2500 match value distribution to the trained pattern. In step 2508, process 2500 applies UI options for depictions. In step 2510, process 2500 applies integration and testing. In step 2512, process 2500 performs deployment operations.

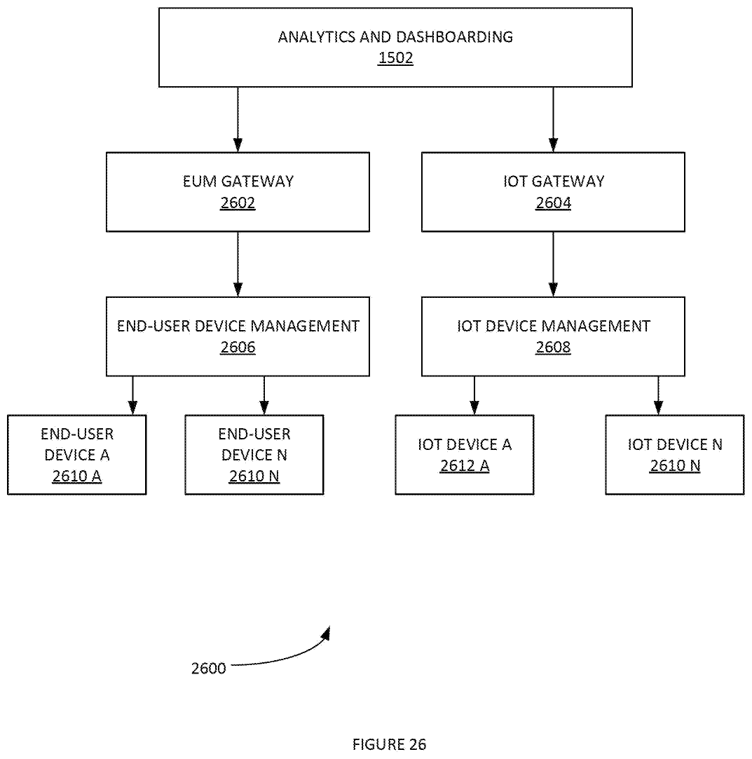

FIG. 26 illustrates an example system 2600 for aggregating risk parameters, according to some embodiments. Analytics and Dashboarding component 1502 can aggregate risk data from End User Management (EUM) gateway 2602 and IoT gateway 2604, respectively. The risk parameter related data is collected from both the end-user device management systems 2604 and IoT device management system 2606. End User Management (EUM) gateway 2602 and IoT gateway 2604 can plug into these systems and collect and summarize the data at frequent/periodic intervals. The summarized data is then presented to Analytics and Dashboarding component 1502 to be available for user insights after processing them through specified AI/ML algorithms. End-user device management systems 2604 and IoT device management system 2606 can obtain risk data from specified end-user devices 2610 A-N and/or IoT devices 2612 A-N.

System 2600 can aggregate risk parameters from devices external to the IT Datacenter (e.g. IOT/End user). All the devices outside the data center (e.g. end-user devices 2610 A-N and/or IoT devices 2612 A-N) can be controlled by management systems, i.e. end-user device management systems 2604 and IoT device management system 2606. End-user device management systems 2604 can be a service management system for end-user devices. IoT device management system 2606 can be operation management systems for managing an Internet of things systems and other devices.

### Advanced Common Controls Framework (ACCF)

An individual standardized published or custom defined Control Framework (CF) defined by industry, legal, statutory, regulator, and geo-requirements is provided. Each CF may cover a specific governance, risk and/or compliance topic enumerated with a number of specific controls to provide coverage with its intended topic.

The Advanced Common Controls Framework (ACCF) is a collection of individual CF's that when combined enable a commingling of individual controls. When using the 80/20 rule of the Pareto Principle this accommodates a simplicity of complexity using root CF to provide efficacy on a 1 to 1, 1 to many or many to many control alignment.

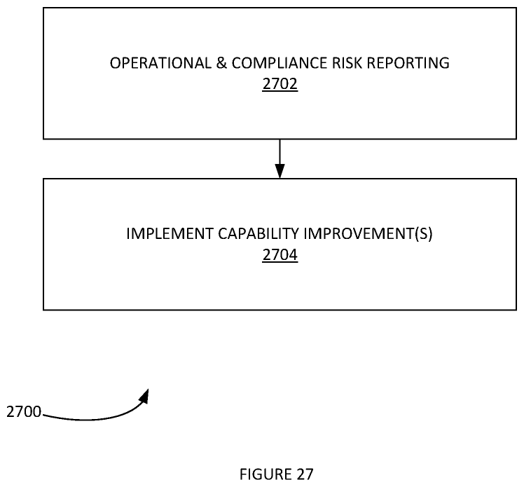

FIG. 27 illustrates an example ACCF process 2700, according to some embodiments. In step 2702, process 2700 can perform operational and compliance risk reporting. This step can utilize/consider various regional and/or national regulations, contractual obligations, statutory requirements, statutory obligations, etc. These can then be applied by a utility that includes multiple frameworks and/or controls.

In step 2704, process 2700 can implement various capability improvement(s). These can include a simplified risk signal analysis with reduction and/or alignment of multiframework controls (e.g. one to one, one to many, many to many). This can also include a robust modeling with hi-fidelity decisional making analytics.

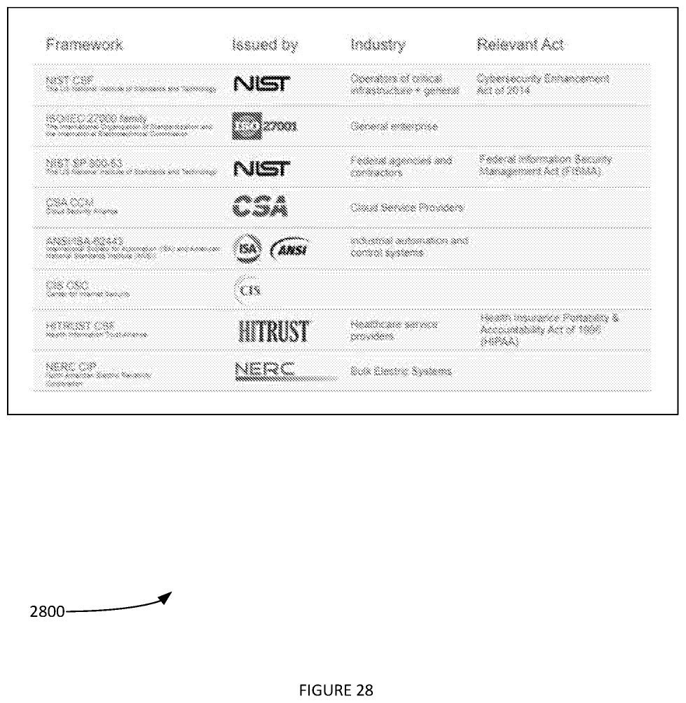

Process 2700 can use a baseline set of control requirements and associated controls (e.g. see FIG. 28). This allows the organization to have a head start on optimizing their controls environment. Accordingly, FIG. 28 illustrates an example baseline set of control requirements, according to some embodiments.

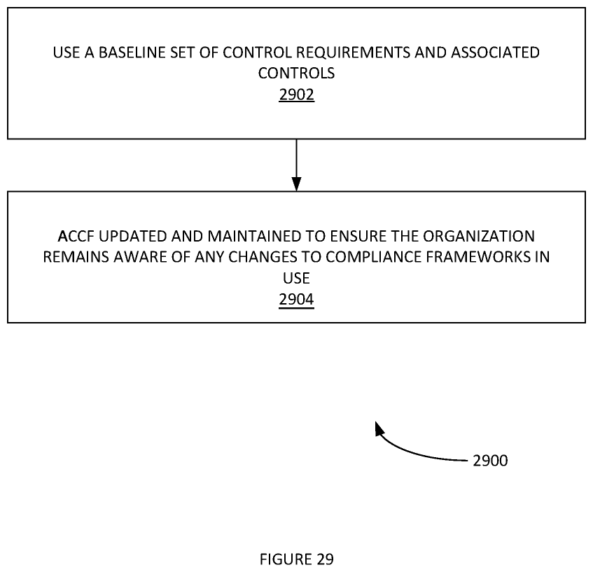

FIG. 29 illustrates an example process 2900 for optimizing a controls environment, according to some embodiments. In step 2902, process 2900 can use a baseline set of control requirements and associated controls. In step 2904, the ACCF can be updated and maintained to ensure the organization remains aware of any changes to the compliance frameworks in use. By leveraging a common control to meet multiple compliance requirements, an organization can gain efficiencies in performing its current audit engagements.

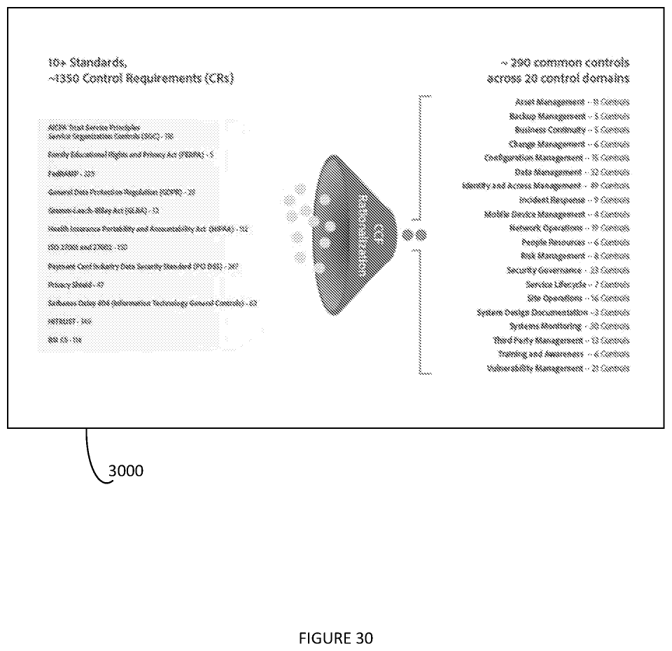

FIG. 30 illustrates an example schematic 3000 showing ACCF rationalization, according to some embodiments. In schematic 3000, 10 plus standards (e.g. around 1350 control requirements) originate from various sources (e.g. AICPA, FERPA, FedRAMP, GDPR, HIPAA, etc.). The standards undergo ACCF rationalization into a set of common controls across a specified set of domains (e.g. 290 common controls across 20 control domains, etc.).

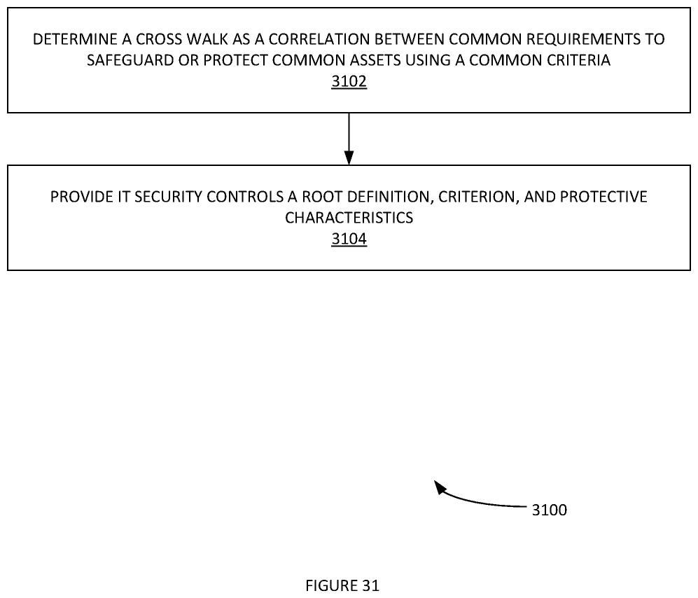

FIG. 31 illustrates an example process 3100 for implementing a cross walk, according to some embodiments. In step 3102, process 3100 can determine a cross walk (e.g. a control mapping, etc.) as a correlation between common requirements to safeguard or protect common assets using a common criteria. Using a specified method (e.g. the 80/20 rule, etc.) process 3100 can provide IT security controls a root definition, criterion, and protective characteristics in step 3104. Thus, allowing the cross walk to align them in a ‘1 to 1’, ‘1 to Many’, or ‘Many to Many’ matrix (e.g. and/or other mapping techniques, etc.).

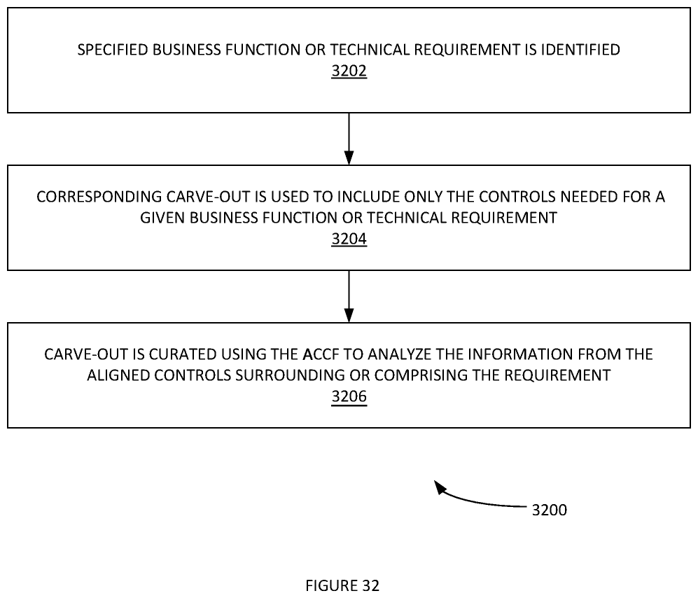

FIG. 32 illustrates an example process 3200 for a carve out, according to some embodiments. An ACCF enables extracting specific controls for specific views such as a region, business unit, compliance requirement, and/or a specific business function. This capability theoretically allows viewing of virtually any topic, asset, or group of them to provide visibility not previously offered. In step 3202, a specified business function or technical requirement is identified. In step 3204, a corresponding Carve-Out is used to include only the controls needed for a given business function or technical requirement. In step 3206, the Carve-Out is curated using the ACCF to analyze the information from the aligned controls surrounding or comprising the requirement. In this way, process 3200, simplifies and improves the clarity (e.g. in terms of fidelity) of the requirement's supporting data used to establish the compliance value/score or other metrics needed.

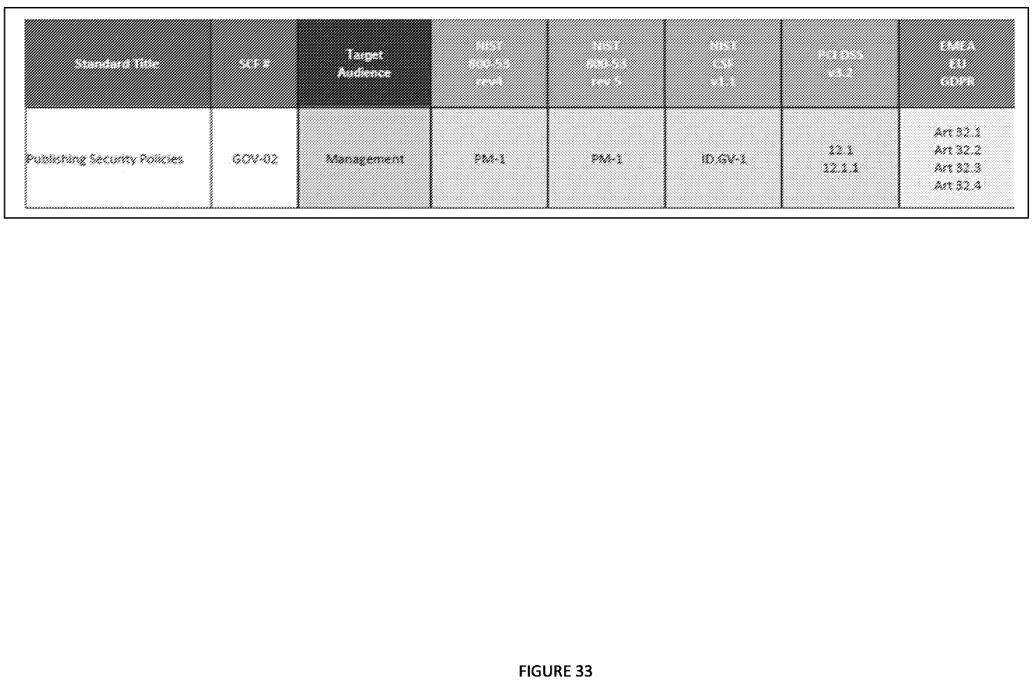

FIG. 33 illustrates an ACCF example, according to some embodiments. This illustration outlines New York Department of Financial Service (NYDFS)s 500 cybersecurity regulations across an ACCF using NIST SP-800.53 r5 as the key (e.g. base) control framework along with associated framework's control alignment. Within this illustration are the various subsections defining control requirements used to fulfill the target requirements.

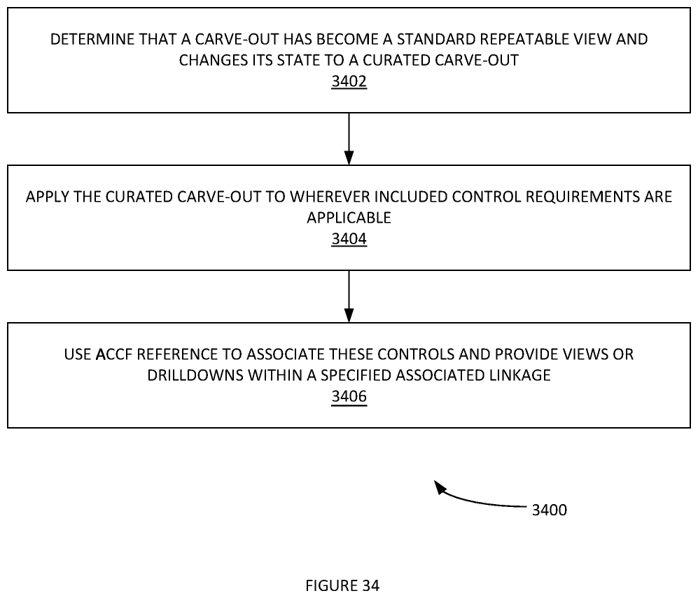

FIG. 34 illustrates an example process 3400 for implementing a curated carve-out, according to some embodiments. In step 3402, process 3400 determines that a carve-out has become a standard repeatable view and changes its state to a curated carve-out. The curated carve-out can have a collection of historical data. The curated carve-out available for display and decisioning. In step 3404, process 3400 then applies the curated carve-out to wherever the included control requirements are applicable. In step 3406, process 3400 uses ACCF reference to associate these controls and provide views or drilldowns within a specified associated linkage. Process 3400 can support a high-fidelity/granularity of details for use across a variety of personas. Three separate personas are defined as Operational, Management and Executive for the embodiments reflective herein.

### Additional Computing Systems

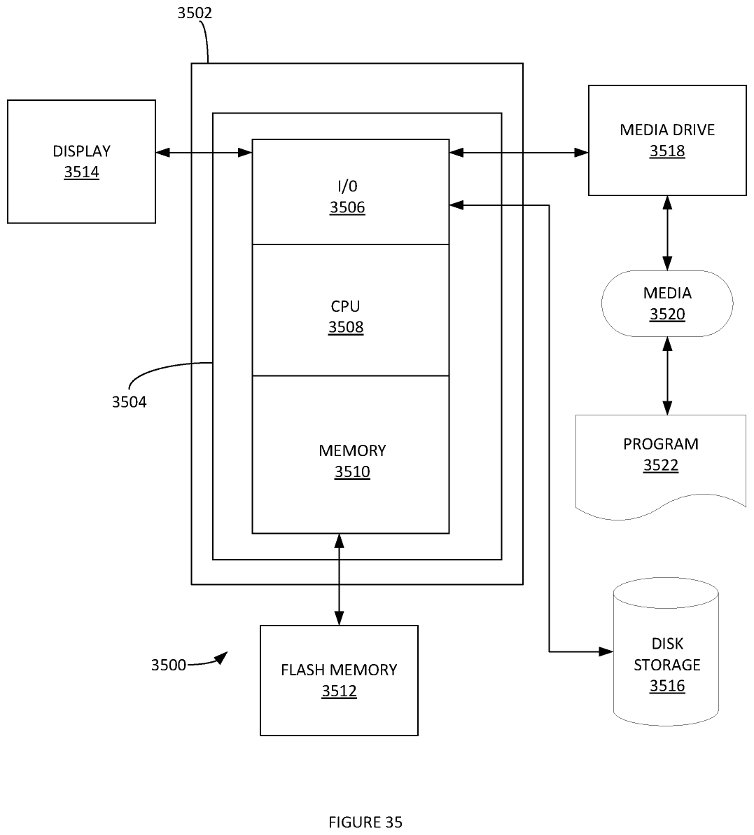

FIG. 35 depicts an exemplary computing system 3500 that can be configured to perform any one of the processes provided herein. In this context, computing system 3500 may include, for example, a processor, memory, storage, and I/O devices (e.g., monitor, keyboard, disk drive, Internet connection, etc.). However, computing system 3500 may include circuitry or other specialized hardware for carrying out some or all aspects of the processes. In some operational settings, computing system 3500 may be configured as a system that includes one or more units, each of which is configured to carry out some aspects of the processes either in software, hardware, or some combination thereof.

FIG. 35 depicts computing system 3500 with a number of components that may be used to perform any of the processes described herein. The main system 3502 includes a motherboard 3504 having an I/O section 3506, one or more central processing units (CPU) 3508, and a memory section 3510, which may have a flash memory card 3512 related to it. The I/O section 3506 can be connected to a display 3514, a keyboard and/or another user input (not shown), a disk storage unit 3516, and a media drive unit 3518. The media drive unit 3518 can read/write a computer-readable medium 3520, which can contain programs 3522 and/or databases. Computing system 3500 can include a web browser. Moreover, it is noted that computing system 3500 can be configured to include additional systems in order to fulfill various functionalities. Computing system 3500 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### Example Common Control Model

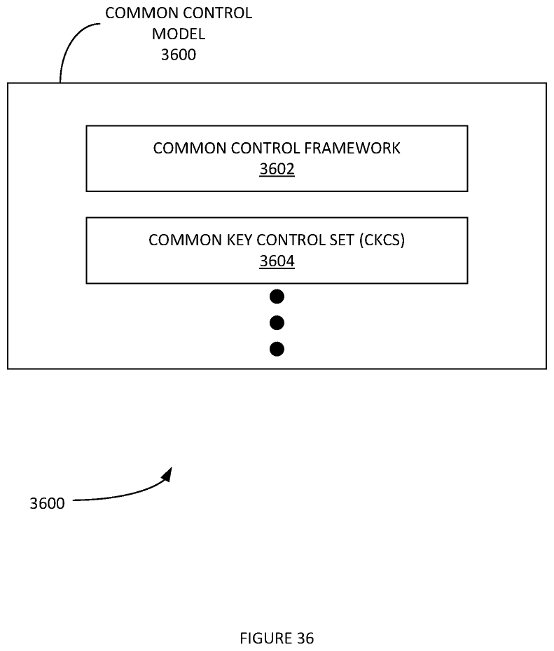

FIG. 36 illustrates an example common control model 3600, according to some embodiments. A Common Control Model (CCM) 3600 includes a Common Control Framework (CCF) 3602 conjoined with an integrated linkage to the Common Key Control Set (CKCS) 3604. These can be aligned with and integral components of an Integrated Risk Modeling and Decisioning Platform.

The CKCS object model 3604 is the overall methodology used to process each control's objective, requirement, and validation. CKCS object model 3604 can be associated sections comprise the Common Key Set and the Control Validation Set as distinct functions (e.g. methods) conjoined to provide the CKCS evaluation work product of control maturity, effectiveness, or compliance (e.g. measurement of risk value by control methodology). The parts of the CKCS 3604 are in turn conjoined with the CCF 3602 representing the full functionality of the CCM methodology.

The CKCS 3604 uses a primary framework within its object model as the pivotal key for all other controls and sets the stage for use of a common control framework. As shown below, the left porting of the overall Risk/Maturity methodology of the CKCS 3604 set up the formal structure for all-inclusive control frameworks to be aligned and conjoined with the Control Validation Set.

Akin to the CKCS 3604 section is the Control Validation Set section which brings the computational process of aligning ingested data with associated control metrics. This completes the CCM 3600 representing a single framework engine only missing its data for the complexity the world brings.

The CCF 3602 is developed with Artificial Intelligence Machine Learning (AIML) using Component Object Models where reusable objects are present for replication and reuse. Within the CCM 3600, the CCF 3602 interacts with the conjoined CKCS sections which is used as the primer for the CCF 3602 and subsequent crosswalks. Crosswalks bring multiple frameworks together as one enabling use of define specific Carve-Outs which are simply understood as a selectable subset of CKCS controls with their crosswalks intact to leverage the economy of scale to ask once and provide data to many frameworks e.g., 1 to 1, 1 to many, and many to many relationships.

The CCF Rationalization methods contain various control frameworks and are integrated between them and the CKCS 3604. These components are used as the primer for the CCM 3600 and its ability to create subsequent crosswalks.

The CKCS Index numeration to the control question level and the indicative inclusion of each within the individual frameworks. This is the CCF object model used to align frameworks to the CKCS Index where the Control Key structure must be maintained to ensure alignment across both object models. Critical to this object model is its ability to append nearly unlimited additional frameworks whether published or custom created.

The ability to ‘Carve-Out’ and drill down from within each defined persona to the relevant level of detail needed for decisioning of that persona is paramount to accurate business decisioning. Using this capability to establish the unique operational characteristics reporting and notification threads from the ‘Single Source of Truth’ (SST) affords each level of business to rely upon the same data set where each has their respective perspective for their role in management of risk.

The uniqueness of carving out a subset of controls and the questions needed to quantify the controls as a basis of functionality offer the ability to dimensionalize risk data in unlimited ways. Using the CCF object model 3602, there is the ability to combine two (2) or more frameworks into a single framework subset (e.g. a Carve-Out). In addition to simply offering unique Carve-Outs, each persona has the ability to create their own unique Carve-Outs and save them for later recall, modeling, or visualization.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations).

Accordingly, the specification and drawings are to be regarded in an illustrative rather than a restrictive sense. In some embodiments, the machine-readable medium can be a non-transitory form of machine-readable medium.

What is claimed by United States patent is:

1. A computerized advanced common controls framework (ACCF) method for all risk domains of cyber security as prescribed in each framework comprising:
providing a risk identification, quantification, and mitigation engine delivery platform of an entity;
obtaining a set of Control Frameworks (CFs) related to a risk identification, quantification, and mitigation engine delivery of the entity;
creating an ACCF from the set of CFs, wherein the ACCF comprises a collection of CFs that when combined enable a commingling of individual controls; and
with the risk identification, quantification, and mitigation engine delivery platform of an entity, applying the ACCF to perform an operational and compliance risk reporting.

2. The computerized ACCF method of claim 1, wherein a CF is defined by an industry source, a legal source, a statutory source, a regulator source, or a geo-requirement source.

3. The computerized ACCF method of claim 2, wherein each CF covers a specific governance, risk or compliance topic enumerated with a number of specific controls to provide coverage with an intended topic.

4. The computerized ACCF method of claim 3, wherein a root CF provides efficacy one-to-one control alignment, one-to-many control alignment or a many-to-many control alignment.

5. The computerized ACCF method of claim 1, wherein the step of applying the ACCF to perform an operational and compliance risk reporting further comprises:
applying a regional or a national regulation as a part of the ACCF to perform the operational and compliance risk reporting.

6. The computerized ACCF method of claim 5, wherein the step of applying the ACCF to perform an operational and compliance risk reporting further comprises:
applying a contractual obligation and a statutory requirement as a part of the ACCF to perform the operational and compliance risk reporting.

7. The computerized ACCF method of claim 6, wherein the step of applying the ACCF to perform an operational and compliance risk reporting further comprises:
applying a statutory obligation as a part of the ACCF to perform the operational and compliance risk reporting.

8. The computerized ACCF method of claim 1 further comprises:
implementing a capability improvement comprising a simplified risk signal analysis with a reduction or an alignment of a plurality of framework controls.

9. The computerized ACCF method of claim 8, wherein the capability improvement comprises a robust modeling with a plurality of hi-fidelity decisional making analytics.

10. The computerized ACCF method of claim 1 further comprising:
optimizing a controls environment of the risk identification, quantification, and mitigation engine delivery platform of an entity during an application of the ACCF by:
using a baseline set of control requirements and associated controls of the of the ACCF.

11. The computerized ACCF method of claim 10 further comprising:
updating the ACCF c to ensure the entity remains aware of any changes to any compliance frameworks in use.

12. The computerized ACCF method of claim 11, wherein the common control meets multiple compliance requirements of the entity such that the entity gains efficiencies in performing an audit engagement.

13. The computerized ACCF method of claim 1, wherein the ACCF enables the extracting of specific controls for a specific view, wherein the specific view comprises region view, a business unit view, a compliance requirement, a specific business function.

14. The computerized ACCF method of claim 13, wherein a specified business function or technical requirement is identified.

15. The computerized ACCF method of claim 14, wherein a corresponding carve-out is used to include only a specified controls used for the specified business function.

16. The computerized ACCF method of claim 15, wherein the carve-out is curated into a curated carve-out using the ACCF to analyze the information from the aligned controls surrounding or comprising the requirement.

17. The computerized ACCF method of claim 15 further comprising:
determining that a carve-out has become a standard repeatable view;
changing a state of the carve-out to a curated carve-out,
wherein the curated carve-out comprises a collection of historical data, and
wherein the curated carve-out is available for display and decisioning.

18. The computerized ACCF method of claim 17 further comprising:
applying the curated carve-out to where an included a control requirement is applicable.

19. The computerized ACCF method of claim 18 further comprising:
using an ACCF reference to associate the control requirement and provide a view or a drilldown within a specified associated linkage.

20. The computerized ACCF method of claim 19 further comprising:
supporting a plurality of high-fidelity/granularity of details for use across a variety of personas.
